(19) United States
(12) Patent Application Publication
(10) Pub. No.: US 2005/0123439 A1
(43) Pub. Date: Jun. 9, 2005

(54) Device for sensing contaminants

(75) Inventors: David L. Patton, Webster, NY (US); Richard W. Wien, Pittsford, NY (US); Steven C. Switalski, Rochester, NY (US); Kevin W. Williams, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/731,230

(22) Filed: Dec. 9, 2003

(51) Int. Cl. G01N 31/22

(52) U.S. Cl. 422/56

(57) ABSTRACT

This invention relates to a test strip comprising a support having thereon a non-sampling area and a sampling area wherein said sampling area further comprises a sampling layer which can react with a target species to form or release a signal compound which is capable of effecting a reaction with silver halide to form a latent image, and a signal amplification layer comprising silver halide. It further relates to a kit containing the test strip and a method of using the test strip.

### FIELD OF THE INVENTION

This invention relates to a test strip, particularly a test kit, for detecting contaminants in the environment and more specifically in food and water and a method for processing and viewing the sensor. The test strip uses silver halide amplification technology.

### BACKGROUND OF THE INVENTION

Easy and effective methods for detecting contaminants, especially of food and water have long been sought. Antibody technology comprises the largest group of rapid methods; a large number of immunology-based rapid assays have been successfully used for detection of toxins, cells and viruses. Many forms of immunology-based rapid assays have been investigated and developed, including immunofiltration (IMF), micro array immunoassay (MAI), enzyme-linked immunofiltration (ELIFA), chemiluminescent immunoassay (CLIA), immunomagnetic separation (IMS), immunoliposome sandwich assay (ILSA), immunochromatography and improved and standard applications of sandwich ELISA. Many of the above are commercially available, evaluated and validated under stringent requirement testing programs. Some rapid test systems incorporate more than one immunology-based technology into the test system to improve specificity and/or sensitivity, such as the use of IMF and ELISA or IMS and ELISA. Immunology-based rapid assays already in existence can be further modified or incorporated into other systems to improve their performance; this obviates the need to create entirely new detection systems.

Many rapid immunological test methods have been reported to deliver results within as little time as 10 minutes to as much as several hours. However, such methods must be used within the context of a total test system, which usually requires one or more additional, more lengthy preparatory steps (8 to 24 hours) to selectively amplify the target prior to rapid testing. Thus, the term “rapid” does not necessarily apply to the entire test process, which in total can require more than a day to complete. Many developed immunodetection methods have not been validated or evaluated to use with food samples. This may be explained, in part, by the fact that food matrices can be complex in biological, physical and chemical characteristics, potentially interfering with immunological reactions and test performance, increasing the likelihood of both false positive and false negative reactions. Food ingredients such as fats, oils, proteins, and additives can result in non-specific binding in immunoassays; additionally, high levels of indigenous micro flora typical in many foods can mask low levels of the target pathogen. When a pathogen is present in low levels in a complex food sample, and the detection method is limited in sensitivity, the target pathogen must usually be separated and/or amplified prior to immunological detection. While most rapid immunological methods have achieved ultimate detection steps of minutes, they still rely on pre-enrichment, immunocapture and/or preincubation steps in order to enhance inherent assay sensitivity and/or specificity. Rapid test methods with innately improved sensitivity and specificity over current methodology would be more successful and applicable to foods. Such highly sensitive rapid methods coupled with a short purification step or improved sampling method (e.g., using IMS or isolating swab samples) could further improve target detection sensitivity and specificity from food samples.

The immunochemical methods available for one common microbe, E. coli, have numerous drawbacks. Most commercially available immunochemical methods use antibodies to the E. coli O-antigen of the O157 serotype, or E. coli O157:H7 as a whole antigen. Using the 0157 antigen alone to test for E. coli O157:H7 may result in a high degree of false-positive results due to non-specific binding by complementary epitopes of other bacterial species. It has been found that E. hermanii O148:NM, E. coli O117:H27 and group N Salmonella cross-reacted with E. coli O157 polyclonal antibodies. The source and type of antigen used can significantly reduce test specificity; in developing the ELISA EHEC-Tek test product for E. coli O157:H7, the use of polyclonal antibodies significantly increased the number of false-positive test results. While polyclonal antibodies are relatively easy and inexpensive to produce, there is much variability in quality, and they are limited in degree of specificity.

Enzyme-based systems currently in commercial use for immunodetection lack the ability to adequately amplify the detection signal. The average working detection limit for these assays is on average 10³-10⁵ cells per ml or per gram of test material, achieved only after selective pre-enrichment and/or purification and concentration step is performed to reduce microbial background and to amplify the target organism. Without an additional amplification step, many of these tests would lack sufficient sensitivity to be useful. An alternate approach to increasing sensitivity is to amplify the target signal detected within the immunodection system; some newer approaches have taken such an approach. One system attempted to eliminate the pre-enrichment step for selective isolation and magnification in a 30-minute rapid IMS assay. This system used a flow-through ceramic bead covalent capture mechanism coupled with ELISA protocols to detect one spore or cell for Bacillus and E. coli using any sample size. However, in this system, a variety of different food matrices were not investigated and the equipment required for analysis would not be readily adaptable to field use or use by non-technical staff. Another used IMB to capture and concentrate target pathogens; amplification occurred by use of a europium or samarium labeled target antibody, released as a highly fluorescent signal upon detecture of the captured analyte. A recently developed approach in a ganglioside-liposome immunoassay amplifies the detection signal by use of red dye filled antibody labeled capture liposomes that migrate to a detection zone, creating a visible color strip. Others have used silver to improve detection by increasing surface immobilization of capture antibodies, or by amplifying the signal of the detection of immuno-gold bound test antigen. In the latter system, the Detex assay kit for E. coli O157:H7 detection, a gold-conjugated antibody binds to the captured target and silver is subsequently deposited on the gold, forming a metallic bridge; changes in electrical resistance are a measure of detection.

There is a continuing need for a system to rapidly detect and identify animal and plant pathogens and other contaminants in the field, particularly microbial and other toxins in food. The system must be robust, portable, and usable by personnel with minimal laboratory training. Further, the test should be flexible enough to be adapted to possible new threats.

### SUMMARY OF THE INVENTION

This invention provides a test strip comprising a support having thereon a non-sampling area and a sampling area wherein said sampling area further comprises a sampling layer which can react with a target species to form or release a signal compound which is capable of effecting a reaction with silver halide to form a latent image, and a signal amplification layer comprising silver halide. It further provides a method of detecting a target species comprising contacting the test strip with the material to be tested and allowing the silver halide to form a latent image. It also comprises a test kit comprising a developing device and the test strip or a kit comprising a transfer device and the test strip.

The invention also provides a test strip array comprising a non-sampling area and multiple sampling areas wherein each sampling area further comprises a sampling layer which can react with a target species to form or release a signal compound which is capable of effecting a reaction with silver halide to form a latent image, and a signal amplification layer comprising silver halide. It further provides a method of detecting a target species comprising contacting all or a portion of the sampling areas of the test strip array of with the material to be tested and allowing the silver halide to form a latent image.

This technology is simple and easy to interpret and the test strip can be used by personnel with very minimal laboratory training. The test is flexible and can be taught in a protocol without losing effectiveness. The test strips are disposable or storable for later reading by more trained personnel. They can be used on any material suspected of contamination, and can be easily used at ports of entry, in production agriculture, and in natural resource environments. In fact, the technology is designed to be so simple that it could be used any place that food is processed, prepared, served, or consumed (kitchens, mess kits, food cartons, etc.).

The test strip can be used with a simple swab of suspected material. A positive result will be indicated by the development of a visual indicator, the amount roughly proportional to the amount of target contaminant. The indicator can be visually detected, or further quantified by use of a hand-held thermal processor and densitometer reader, equipment easy to use by non-technical personnel. The method is rapid, giving results in possibly as little as 30 minutes or less. Due to the unique silver halide based amplification technology, the test strip will be able to detect very low levels of a contaminant, without preamplification. In one embodiment the appearance of a color will provide a signal of the presence of a contaminant. The amount of color is proportional to the amount of contaminant present and can be more carefully measured to determine the extent of the suspected contaminant. The test strip may use any number of detection methods.

The test strip can be designed with multiple coatings so that areas of the test strip are selective to different suspect pathogens. The coating process is well known and is very reproducible and consistent. Both the upper layers and the silver halide layers can be coated to known thickness, with known silver content and silver grain size. In this way, sensor elements can be fabricated that provide the same response for the same amount of suspect material. The ability to formulate a multiple test strip has a distinct advantage in cost and efficiency in usage.

Additionally the test strip of the invention could improve sample preparation. Foods could be tested without extensive handling or preparation.

### BRIEF DESCRIPTION OF THE DRAWINGS

Other objects, advantages and features of the present invention will become apparent from the following specification when taken in conjunction with the drawings in which like elements are commonly enumerated and in which:

FIG. 1 illustrates a cross section of a structure of a typical multilayer sensor made in accordance with the present invention;

FIG. 2 illustrates a cross section of another embodiment of the multilayer sensor of FIG. 1;

FIG. 3 illustrates a cross section of yet another embodiment of the multilayer sensor of FIG. 1 made in accordance with the present invention;

FIG. 4 illustrates an embodiment of the multilayer sensor of FIG. 1 in the form of a test strip;

FIGS. 5 and 6 are a schematics illustrating how a sample is obtained from a test object such as a carcass using the test strip of FIG. 4;

FIG. 7 is a schematic illustrating yet another embodiment of the present invention having multiple coatings for testing for multiple pathogens on the test strip of FIG. 4;

FIGS. 8 and 9 are schematics illustrating another embodiment of how a sample is obtained from a test object using the test strip of FIG. 4;

FIG. 10 is a schematic illustrating how the multilayer sensor of FIG. 4 is chemically processed;

FIGS. 11 and 12 are schematics illustrating how the multilayer sensor of FIG. 4 can be heat processed;

FIGS. 13 and 14 illustrate the multilayer sensor after it has been processed using the methods of FIGS. 10, 11, or 12 in accordance with the present invention;

FIGS. 15 and 16 illustrate another embodiment of the test strip after it has been processed using the methods of FIGS. 10, 11, or 12 in accordance with the present invention; and

FIG. 17 illustrates a test strip array comprising more than one of the test strips of FIG. 4 in accordance with the present invention.

### DETAILED DESCRIPTION OF THE INVENTION

The test strip and test strip array of the invention utilize the following described sensor technology. The sensor used in the invention takes advantage of the amplification of photographic silver halide. When a silver halide grain has as little as 3 constituent atoms reduced to silver (known as a “latent image”), the grain can be developed or completely converted to a grain of silver. The development may be done with chemical development (either time-released, triggerable, or manually with a development solution), or with heat development (as in dry film development systems, such as the Kodak DryView X-ray film system). The atoms changed to silver are usually triggered by light, and as little as 3 photons are needed to create the silver atom of the cluster forming the latent image. This means that a very small stimulus can be stored, and then amplified chemically by the silver halide grain itself, by more than a million fold.

In this sensor system the latent image is formed by the diffusion of chemically active species (signal compound) (e.g., free radicals, redox species, etc.) that are produced or released in the upper layers. Since these active chemical species are released by the interaction of the suspect pathogen or contaminant with the upper layers of the film, the latent image is tied to the presence of the pathogen or contaminant. Development of this latent image can either proceed spontaneously, as the latent image builds up from the original dose, or can be triggered chemically or thermally. The triggered development has all the amplification capability of the silver halide grain.

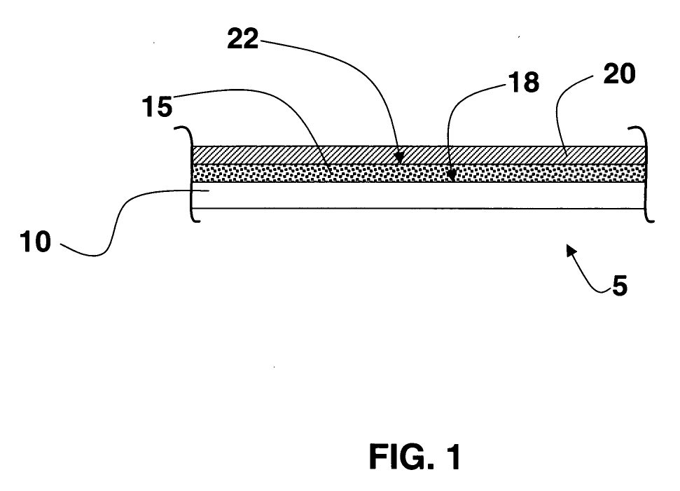

The sensor comprises a support, a sampling layer, and a signal amplification layer comprising silver halide. Referring to FIG. 1, there is illustrated a cross-sectional view of a multilayer sensor 5, which in the embodiment illustrated, comprises a support layer 10 with a signal amplification layer 15 comprising silver halide coated on the top surface 18 of the support layer 10 and a sampling layer 20 coated on the top surface 22 of the signal amplification layer 15. The sampling layer and the signal amplification layer may be the same layer, and this invention is intended to include such an embodiment. In such an embodiment the silver halide grains and the reactive material of the sampling layer may be blended homogeneously or may be regionalized. Generally the sensor is in the form of a test strip.

The sampling layer is able to react with a target species (pathogens, contaminants, etc.) to form or release a signal compound which can effect a reaction with the silver halide to form a latent image. Examples of contaminants include microbes and various toxins. Chemical toxins might include, for example, methyl chloride, cyclohexane, ammonia, phosgene, Sarin, other organophosphates, etc. Microbes might include, for example, Campylobacter spp. C. jejuni, Listeria monoctyogenes, Salmonella spp., and Clostridium botulinum. Chemicals which may indicate food spoilage might include, for example, cadaverene, putrescine, and trimethylamine. One particular contaminant of interest is E. coli. The sampling layer contains an interactive material which reacts with the target species to form or release a signal compound as described below. The target species may cause the sampling layer to release the signal compound or the signal compound may be formed through a reaction between the target species and a component of the sampling layer, either through a single reactive step or through a chemical cascade. The signal compound may effect the reaction with silver halide either by itself diffusing to the silver halide layer or through a chemical cascade through intervening layers. The signal compound can effect a direct reaction with the silver halide to form a latent image, or it can react with a secondary compound contained in the silver halide layer which can then react with the silver halide to form a latent image.

Several different types of latent image forming chemical systems (LIFCS) may be used with diffusible detection chemistry—that is, the signal compound may effect a reaction with silver halide in many different ways. The LIFCS include, but are not limited to, the use of redox agents; sulfur-containing agents; both of the previous categories combined with pH changes; and both of the previous categories resulting from free radical chemistry. There are also a number of mechanisms that can couple the latent image forming chemistry with enzyme and EIA chemical systems. Some of these systems include unique developable coupler chemistry, but many use standard chemistry that can be used with available coupler chemistry.

In one specific embodiment the sampling layer may comprise L-methionine which reacts with E. coli in the presence of the enzyme L-methionine γ-lyase to form methanethiol, the signaling compound. Methanethiol reacts with silver halide to form a latent image.

Another method to provide a signal is to use an Enzyme Immunoassay (EIA) coupled with the silver halide amplification system. In the EIA, an enzyme is conjugated to an immuno reactant (either the antigen or the antibody), and the expression of the enzyme can then indicate the presence or absence of the antigen or antibody. The enzyme's action on the substrate for the enzyme produces a product, which is either an LIFCS, triggers the release of an LIFCS, or is used in subsequent chemical reactions to release an LIFCS. In one example, the enzyme is methionine gamma lyase, whose substrate is methionine, and the LIFCS is the methanethiol that is released from the reaction of the enzyme with the substrate. In one version of EIA, the enzyme is conjugated to the antibody, which is in competition with unconjugated antibody for the antigen, which is E. coli. The amount of expressed signal, which is caused by the interaction of the LIFCS, methanethiol, with the emulsion layer to form the latent image, is related to the amount of E. coli present. This is an example of ELISA, which is an example of a heterogeneous assay.

In another method, a form of EIA which is an example of a homogeneous assay is used. In this method, the enzyme, substrate, and antibody are again methanethiol, methionine, and the antibody to E. coli, respectively. The enzyme-conjugated antibody's reaction with the methionine is measured without competition with the unconjugated antibody.

Similarly, the enzyme can be p-benzoquinone reductase; the substrate is NADPH and p-benzoquinone; and the product is NADP and hydroquinone. The released hydroquinone is the LIFCS. The enzyme-antibody conjugate is p-benzoquinone reductase conjugated to an antibody to E. coli. This can be used in either the format in example 3 or example 4.

From the above discussion, it can be seen that all the different EIA listed by Nakamura et al. can be used with this silver amplification system. Additionally, methionine gamma lyase and p-benzoquinone reductase are not the only enzymes, and methionine and p-benzoquinone are not the only substrates that can be used. In this way, the system uses an LIFCS rather than fluorescence to generate a signal, and because it uses the silver amplification system, can increase the signal by a factor of over a million, as compared to other EIA methods. Specificity is only limited by the antibody, and sensitivity is only limited by the latent-imaging forming ability of the LIFCS and the amplification of the silver emulsion.

Also, it is clear that all assays that use supports or supported antibodies can be used in the sample layer, and can also use the sample layer as a support. One example is a “sandwich” immunoassay. An example, using antibodies and fluorescence detection, is disclosed by Delehanty and Ligler (Analytical Chemistry, Vol. 74, No. 21, pp. 5681-5687). This has been modified to incorporate an enzyme conjugated to the antibody (see example 2). The antibody-enzyme conjugate can use a substrate, typically in the sample layer, to release an LIFCS, and cause a latent image in the silver emulsion layer. The latent image can be developed later, resulting in greater than a million-fold amplification of the signal.

Other examples wherein the chemical cascade forms a thiol which reacts with silver halide are shown below. 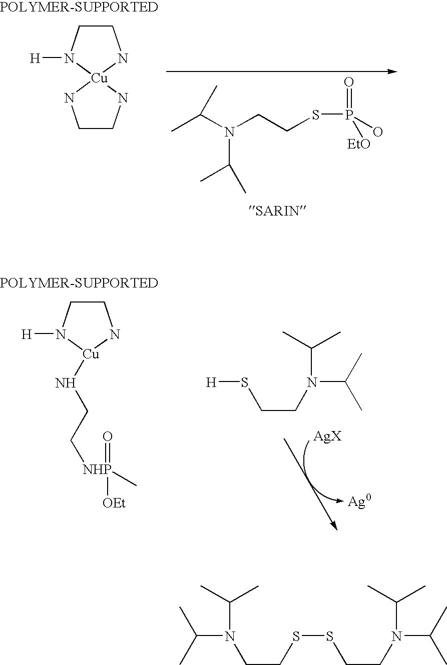
Reference: Polymers for Advanced Technologies (2001), 12 (3-4)

There are various chemical cascades based on SARIN.
1) SARIN is known to react with hydroxylamines that cause hydrolysis of the P—S bond

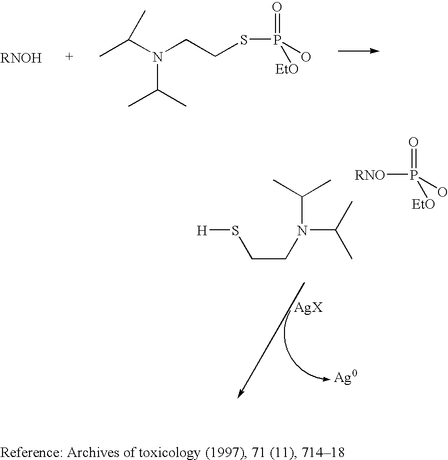

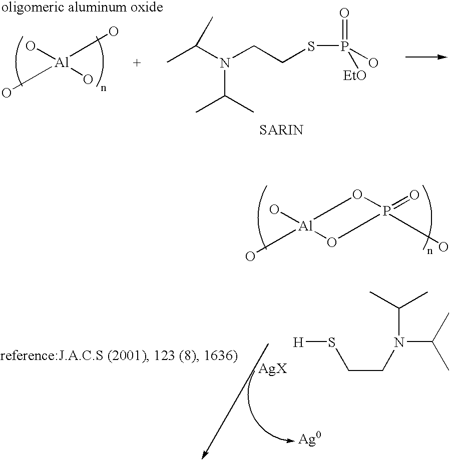

The following is a reaction with cadavarene, putrescine:

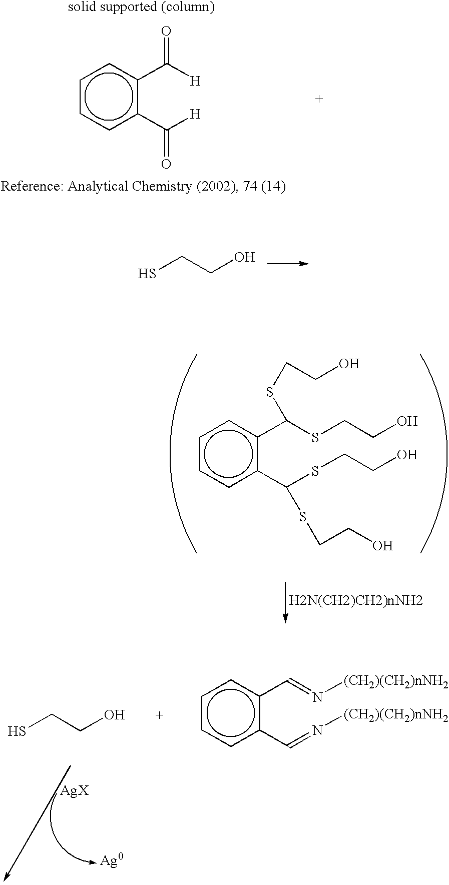

Clearly, the sample layer can incorporate an immobilizing material, such as a polymeric support, that allows a chemical reaction (see example 4). A material, not allowed to diffuse (because of size, solubility, or physical or chemical immobilization) beyond the sample layer, can react with a chemical. This chemical can be the toxin of interest, or the result of a toxic process of interest, such as cadaverene. The chemical reaction is designed to release an LIFCS, such as a thiol, so that the presence of the chemical (cadaverene) is detected when the silver latent image is developed, again increasing the signal by over a million-fold.

The sampling layer may be one layer or it may have sub-layers. It could comprise a spreading sub-layer in fluid contact with a reagent layer, wherein the spreading layer is capable of spreading within itself a substance including at least a component of a liquid sample or a reaction product of such component to provide a uniform concentration of such spread substance at the surface of the spreading layer facing the reagent layer. Spreading may result from and is limited by a combination of forces such as hydrostatic pressure of a liquid sample, capillary action within the spreading layer, surface tension of the sample, wicking action of layers in fluid contact with the spreading layer, and the like. As will be appreciated, the extent of spreading is dependent in part on the volume of liquid to be spread. However, it should be emphasized that the uniform concentration obtained with spreading is substantially independent of liquid sample volume and will occur with varying degrees of spreading. As a result, sensors of this invention do not require precise sample application techniques. However, a particular liquid sample volume may be desirable for reasons of preferred spread times or the like. Because the sensors of this invention are able to produce quantitative results using very small sample volumes that could be entirely taken up within a conveniently sized region of the spreading layer, there is no need to remove excess moisture from the element after application of a liquid sample. The spreading layer need only produce a uniform concentration of spread substance per unit area at its surface facing a reagent layer with which the spreading layer is in fluid contact, and it is very convenient to determine whether a particular layer can be suitable for spreading purposes. Such uniformity of concentration can be determined by densitometric or other analytical techniques, as by scanning the appropriate surface or reagent layer or other associated layer to determine the apparent concentration of spread substance or of any reaction product based on the concentration of spread substance. An appropriate test is described in detail in U.S. Pat. No. 3,992,158, incorporated herein by reference.

Useful spreading or metering layers can be isotropically porous layers. Such layers can be prepared using a variety of components. In one aspect, particulate material can be used to form such layers, wherein the isotropic porosity is created by interconnected spaces between the particles. Various types of particulate matter, all desirably chemically inert to sample components under analysis, are useful. Pigments, such as titanium dioxide, barium sulfate, zinc oxide, lead oxide, etc., are desirable. Other desirable particles are diatomaceous earth and microcrystalline colloidal materials derived from natural or synthetic polymers. Microcrystalline cellulose is an example of such a colloidal material which is satisfactory for use in the present invention. Spherical particles of uniform size or sizes, such as resinous or glass beads, can also be used and may be particularly desirable where uniform pores are advantageous, such as for selective filtration purposes. If a particulate material of choice is not adherent, as in the case of glass beads or the like, it can be treated to obtain particles that can adhere to each other at points of contact and thereby facilitate formation of an isotropically porous layer. As an example of suitable treatment, non-adherent particles can be coated with a thin adherent layer, such as a solution of hydrophilic colloid like gelatin or polyvinyl alcohol, and brought into mutual contact in a layer. When the colloid coating dries, the layer integrity is maintained and open spaces remain between its component particles. As an alternative or in addition to such particulate materials, the spreading layer can be prepared using isotropically porous polymers such as described in U.S. Pat. No. 3,992,158, incorporated herein by reference.

The reagent layer would be the sub-layer of the sampling layer which is able to react with a target species (pathogens, contaminants, etc), to form or release a signal compound which can effect a reaction with the silver halide to form a latent image. If the sampling layer does not comprise sub-layers such as a spreading layer, the reagent layer and sampling layer may be the same. Reagent layers in the sensors of this invention are desirably uniformly permeable, and optionally porous if appropriate, to substances spreadable within the metering or spreading layer and to reaction products of such substances. As used herein the term permeability includes permeability arising from porosity, ability to swell or any other characteristic. Such layers can include a matrix in which is distributed, i.e., dissolved or dispersed, a material that is interactive with a target species or a precursor to or a reaction product of a target species. The choice of a matrix material is, of course, variable and dependent on the intended use of the element. Desirable matrix materials can include hydrophilic materials including both naturally occurring substances like gelatin, gelatin derivatives, hydrophilic cellulose derivatives, polysaccharides such as dextran, gum arabic, agarose, and the like, and also synthetic substances such as water-soluble polyvinyl compounds like poly (vinyl alcohol) and poly (vinyl pyrrolidone), acrylamide polymers, etc. Organophilic materials such as cellulose esters and the like can also be useful, and the choice of materials in any instance will reflect the use for which a particular sensor is intended. To enhance permeability of the reagent layer, if not porous, it is often useful to use a matrix material that is moderately swellable in the solvent or dispersion medium of liquid under analysis. The choice of a reagent layer matrix, in any given instance, may also depend in part on optical properties of the resultant layers. Also, it may be necessary to select a material that is compatible with the application of adjacent layers during manufacture of the sensor.

Within the reagent layer (or sampling layer if no reagent sub-layer is utilized) is distributed a material that can interact with a target species as described to form or release a signal compound. The distribution of interactive material can be obtained by dissolving or dispersing it in the matrix material. Although uniform distributions are often preferred, they may not be necessary if the interactive material is, for example, an enzyme. The target species under analysis may advantageously be immobilized in the reagent layer, particularly when the reagent layer is porous. The particular interactive materials that may be distributed within a reagent layer will depend on the analysis of choice.

In preparing sensors of this invention a convenient method is to coat an initial layer on a support, as desired, and thereafter to coat successive layers directly on those coated previously. Such coating can be accomplished by hand, using a blade coating device or by machine, using techniques such as dip or bead coating. If machine coating techniques are used, it is often possible to coat adjacent layers simultaneously, using hopper coating techniques well known in the preparation of light-sensitive photographic films and papers. If it is essential or desirable that adjacent layers be discrete, and maintenance of layer separation by adjustment of coating formulation specific gravity is not satisfactory, as possibly in the case of porous spreading layers, the appropriate selection of components for each layer, including solvent or dispersion medium, can minimize or eliminate interlayer component migration and solvent effects, thereby promoting the formation of well-defined, discrete layers. Any interlayer adhesion problems can be overcome without harmful effect by means of surface treatments including extremely thin application of subbing materials such as are used in photographic films.

For reagent layers, a coating solution or dispersion including the matrix and incorporated interactive materials can be prepared, coated as discussed herein and dried to form a dimensionally stable layer. The thickness of any reagent layer and its degree of permeability are widely variable and depend on actual usage. Dry thicknesses of from about 10 microns to about 100 microns have been convenient, although more widely varying thicknesses may be preferable in certain circumstances. For example, if comparatively large amounts of interactive material, e.g., polymeric materials like enzymes, are required, it may be desirable to use slightly thicker reagent layers.

In addition to its uniform permeability, the reagent layer is desirably substantially free from any characteristic that might appear as or contribute to mottle or other noise in the detection of an analytical result produced in the sensor. For example, any variations in color or in texture within the reagent layer, as could occur if certain fibrous materials, e.g., some papers, are used as a permeable medium, may be disadvantageous due to non-uniform reflectance or transmittance of detecting energy. Further, although fibrous materials like filter and other papers are generally permeable overall, some such materials typically can exhibit widely ranging degrees of permeability and may not exhibit uniform permeability, for example, based on structural variations such as fiber dimensions and spacing. However, such fibrous materials may have other advantages and are not excluded from the invention. Spreading layers and reagent layers of the present elements include materials consistent with appropriate sample spreading and result detection within such layers as discussed elsewhere herein.

Spreading layers can also be prepared by coating from solution or dispersion. The range of materials useful for inclusion in any spreading layer is widely variable as discussed herein and will usually include predominantly materials that are resistant to, i.e., substantially non-swellable upon contact with, the liquid under analysis. Swelling of about 10-40 percent of the layer's dry thickness may be normal. The thickness of the spreading layer is variable and will depend in part on the intended sample volume, which for convenience and cleanliness the spreading layer should be able to absorb, and on the layer's void volume, which also affects the amount of sample that can be absorbed into the layer. Spreading layers of from about 50 microns to about 300 microns have been particularly useful. However, wider variations in thickness are acceptable and may be desirable for particular elements.

The components of any particular layer of a sensor of this invention, and the layer configuration of choice, will depend on the use for which a sensor is intended. As stated previously, spreading layer pore size can be chosen so that the layer can filter out undesirable sample components that would, for example, interfere with an analytical reaction or with the detection of any test result produced within the element. If desirable, a sensor can include a plurality of spreading layers, each of which may be different in its ability to spread and filter. Also, if a restraint on transport of substances within the element additional to that provided by spreading layers is needed, a filter or dialysis layer can be included at an appropriate location in the element.

In the sampling layers of the element, it can be advantageous to incorporate one or more surfactant materials such as anionic and nonionic surfactant materials. They can, for example, enhance coatability of layer formulations and enhance the extent and rate of spreading in spreading layers that are not easily wetted by liquid samples in the absence of an aid such as a surfactant. Interactive materials can also be present in the spreading layer if desirable for a particular analysis. In layers of the sensor it can also be desirable to include materials that can render non-active in the analysis of choice by chemical reaction or otherwise, materials potentially deleterious to such analysis.

As a whole, the sampling layer is preferably diffusible to the signaling compound. As noted above, this may be accomplished by enhancing the permeability of the layer by changing either the diffusivity or the solubility of the layer towards the signaling compound. The diffusivity is effected mainly by the pore size, which can be adjusted with the amount of hardener used to crosslink the gelatin; with addition of various polymers, with addition of beads of polymer, clay, etc.; with the addition of various inorganic materials such as clay, titania, alumina, etc.; and as described above for the sampling or reagent sub-layers. The solubility of the layer can be changed with similar additions as listed for diffusivity, but also the presence of other inorganic and organic addenda, including nanoparticles, such as solid dye dispersions, oily coupler dispersions, etc., and may be dependent on the target species which is tested. The signal compound should be able to diffuse through the sampling layer at a rate of 100 microns/minute, preferably 100 microns/second. The sampling layer may have a thickness of 1 mm to 0.01 microns, and more preferably 100 microns to 0.1 microns.

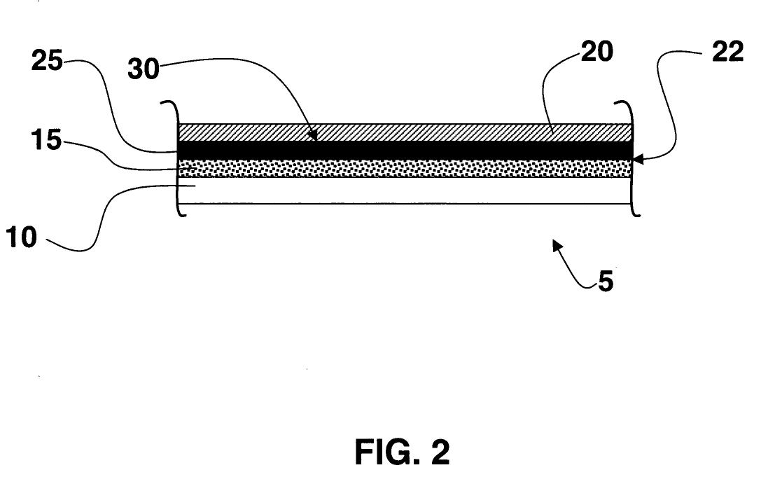

In one embodiment the multilayer sensor 5 further comprises a blocking layer (25) which blocks electromagnetic radiation which is capable of exposing the silver halide. One embodiment made in accordance with the present invention is shown in FIG. 2, wherein the additional blocking layer 25 is coated on the top surface 22 of the amplification layer 15. If such a layer is not present the sensor 5 may have to be protected from light or other exposing radiation by some other means, such as being stored and utilized in some type of light-blocking container. The electromagnetic radiation which must be blocked will be dependent on the type of silver halide utilized and the method of sensitization utilized; for example, it may block all visible light, or only a portion of the visible spectrum. It may also only be necessary that ultraviolet light is blocked. The purpose of the light-blocking layer 25 is to prevent accidental and unintended exposure of the silver halide. In FIG. 2 the sampling layer 20 is coated on the top surface 30 of the blocking layer 25.

The light-blocking layer may block light by any effective method. It may absorb electromagnetic radiation, scatter electromagnetic radiation, reflect electromagnetic radiation, or physically prevent the passage of light. In one preferred embodiment the light-blocking layer is opaque. The light-blocking layer may contain a colorant. The colorant may be a pigment or solid particle dispersion of dye classes including but not limited to oxonol, merocyanine, phthalocyanine, and cyanines as described U.S. Pat. No. 5,213,956. Particularly useful are those of the barbituric acid oxonol class, as those described in U.S. Pat. No. 5,723,272, contained in a solid dye dispersion; or a suspended pigment, such as carbon black; or a dye such as the one shown below; or a Reactive Black such as Reactive Black 26 or Reactive Black 31.

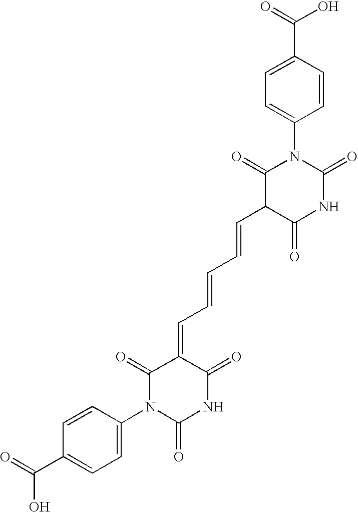

The light-blocking layer may also contain non-light sensitive silver, such as Cary Lea silver. It may also contain filter dyes such as pyrazolone oxonol dyes, such as the one shown below. The dyes may be heat-bleachable as those described in U.S. Pat. No. 6,558,880 and become colorless during development.

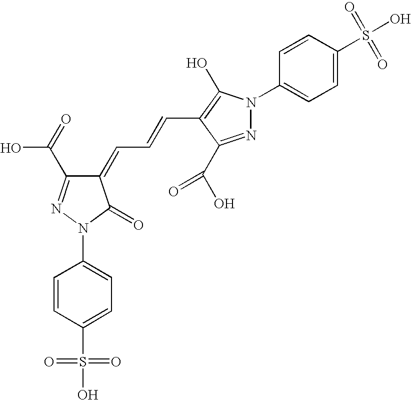

In one embodiment, shown in FIG. 2, the light-blocking layer is positioned between the sampling layer and the silver halide layer. In another embodiment the sampling layer 20 is located between the light-blocking layer 25 and the silver halide layer 15. In another embodiment the sampling layer also blocks electromagnetic radiation which is capable of exposing the silver halide, i.e., the sampling layer and the light-blocking layer are the same layer.

Preferably the light-blocking layer is diffusible to chemical species. If the light-blocking layer is positioned between the sampling layer and the silver halide layer the light-blocking layer is preferably diffusible to the signal compound. If the sampling layer is located between the light-blocking layer and the silver halide layer the light-blocking layer is preferably diffusible to the target species. This may be accomplished by enhancing the permeability of the layer by changing either the diffusivity or the solubility of the layer towards the signaling compound as described above for the sampling layer, or for the target species, and may be dependent on the target species which is tested. The signal compound or target species should be able to diffuse through the light-blocking layer at a rate of 100 microns/minute, preferably 100 microns/second. The light-blocking layer may have a thickness of 1 mm to 0.01 microns, and more preferably 100 microns to 0.1 microns.

The light-blocking layer may comprise any conventional dispersing medium capable of being used in photographic emulsions. Specifically, it is contemplated that the dispersing medium be an aqueous gelatino-peptizer dispersing medium, of which gelatin—e.g., alkali treated gelatin (cattle bone and hide gelatin) or acid treated gelatin (pigskin gelatin) and gelatin derivatives—e.g., acetylated gelatin, phthalated gelatin, and the like are specifically contemplated. Examples of useful hydrophilic binders include, but are not limited to, proteins and protein derivatives, gelatin and gelatin derivatives (hardened or unhardened, including alkali- and acid-treated gelatins, and deionized gelatin), cellulosic materials such as hydroxymethyl cellulose and cellulosic esters, acrylamide/methacrylamide polymers, acrylic/methacrylic polymers, polyvinyl pyrrolidones, polyvinyl alcohols, poly(vinyl lactams), polymers of sulfoalkyl acrylate or methacrylates, hydrolyzed polyvinyl acetates, polyamides, polysaccharides (such as dextrans and starch ethers), and other naturally occurring or synthetic vehicles commonly known for use in aqueous-based photographic emulsions (see, for example, Research Disclosure, September 1996, item 38957, noted above). Cationic starches can also be used as peptizers for emulsions containing tabular grain silver halides as described in U.S. Pat. No. 5,620,840 (Maskasky) and U.S. Pat. No. 5,667,955 (Maskasky). Particularly useful hydrophilic binders are gelatin, gelatin derivatives, polyvinyl alcohols, and cellulosic materials. Gelatin and its derivatives are most preferred, and comprise at least 75 weight % of total binders when a mixture of binders is used. Aqueous dispersions of water-dispersible polymer latexes may also be used, alone or with hydrophilic or hydrophobic binders described herein. Such dispersions are described in, for example, U.S. Pat. No. 4,504,575 (Lee), U.S. Pat. No. 6,083,680 (Ito et al), U.S. Pat. No. 6,100,022 (Inoue et al), U.S. Pat. No. 6,132,949 (Fujita et al), U.S. Pat. No. 6,132,950 (Ishigaki et al), U.S. Pat. No. 6,140,038 (Ishizuka et al), U.S. Pat. No. 6,150,084 (Ito et al), U.S. Pat. No. 6,312,885 (Fujita et al), U.S. Pat. No. 6,423,487 (Naoi), all of which are incorporated herein by reference.

Hardeners for various binders may be present if desired. Useful hardeners are well known and include diisocyanate compounds as described for example, in EP 0 600 586 B1 (Philip, Jr. et al) and vinyl sulfone compounds as described in U.S. Pat. No. 6,143,487 (Philip, Jr. et al), and EP 0 640 589 A1 (Gathmann et al), aldehydes and various other hardeners as described in U.S. Pat. No. 6,190,822 (Dickerson et al). The hydrophilic binders used in the materials are generally partially or fully hardened using any conventional hardener. Useful hardeners are well known and are described, for example, in T. H. James, The Theory of the Photographic Process, Fourth Edition, Eastman Kodak Company, Rochester, N.Y., 1977, Chapter 2, pp. 77-78.

In one embodiment, wherein the light-blocking layer is between the sampling layer and the silver halide layer, the signal compound is capable of effecting a reaction with the silver halide by reacting with the light-blocking layer to effect a reaction with silver halide to form a latent image. The signal compound may react with a component in the light-blocking layer either through a single reactive step or through a chemical cascade.

The silver halide emulsions utilized in this invention may be comprised of, for example, silver chloride, silver bromide, silver iodide, silver bromoiodide, silver bromochloride, silver iodochloride, silver bromoiodochloride and silver iodobromochloride emulsions. It is contemplated that the silver halide emulsions may take the form of a variety of morphologies including those with cubic, tabular and tetra decahedral grains with {111} and {100} crystal faces. The grains may take the form of any of the naturally occurring morphologies of cubic lattice type silver halide grains. Further, the grains may be irregular such as spherical grains.

The grains can be contained in any conventional dispersing medium capable of being used in photographic emulsions. Specifically, it is contemplated that the dispersing medium be an aqueous gelatino-peptizer dispersing medium, of which gelatin—e.g., alkali treated gelatin (cattle bone and hide gelatin) or acid treated gelatin (pigskin gelatin) and gelatin derivatives—e.g., acetylated gelatin, phthalated gelatin, and the like are specifically contemplated. When used, gelatin is preferably at levels of 0.01 to 100 grams per total silver mole. Conventional emulsions are illustrated by Research Disclosure, Item 38755, September 1996, I. Emulsion grains and their preparation.

In one embodiment the silver halide grains are predominantly silver chloride. By predominantly silver chloride, it is meant that the grains of the emulsion are greater than about 50 mole percent silver chloride. Preferably, they are greater than about 90 mole percent silver chloride; and optimally greater than about 95 mole percent silver chloride. The silver halide emulsions utilized in this embodiment may be comprised of, for example, silver chloride, silver bromochloride, silver iodochloride, silver bromoiodochloride and silver iodobromochloride emulsions. Particularly useful are cubic silver chloride emulsions.

In another embodiment tabular grain silver halide emulsions may be utilized. Tabular grains are those having two parallel major crystal faces and having an aspect ratio of at least 2. The term “aspect ratio” is the ratio of the equivalent circular diameter (ECD) of a grain major face divided by its thickness (t). Tabular grain emulsions are those in which the tabular grains account for at least 50 percent (preferably at least 70 percent and optimally at least 90 percent) of the total grain projected area. Preferred tabular grain emulsions are those in which the average thickness of the tabular grains is less than 0.3 micrometer (preferably thin—that is, less than 0.2 micrometer and most preferably ultra thin—that is, less than 0.07 micrometer). The major faces of the tabular grains can lie in either {111} or {100} crystal planes. The mean ECD of tabular grain emulsions rarely exceeds 10 micrometers and more typically is less than 5 micrometers.

In their most widely used form tabular grain emulsions are high bromide {111} tabular grain emulsions. Such emulsions are illustrated by Kofron et al U.S. Pat. No. 4,439,520; Wilgus et al U.S. Pat. No. 4,434,226; Solberg et al U.S. Pat. No. 4,433,048; Maskasky U.S. Pat. Nos. 4,435,501; 4,463,087; and 4,173,320; Daubendiek et al U.S. Pat. Nos. 4,414,310 and 4,914,014; Sowinski et al U.S. Pat. No. 4,656,122; Piggin et al U.S. Pat. Nos. 5,061,616 and 5,061,609; Tsaur et al U.S. Pat. Nos. 5,147,771; 5,147,772; 5,147,773; 5,171,659; and 5,252,453; Black et al 5,219,720 and 5,334,495; Delton U.S. Pat. Nos. 5,310,644; 5,372,927; and 5,460,934; Wen U.S. Pat. No. 5,470,698; Fenton et al U.S. Pat. No. 5,476,760; Eshelman et al U.S. Pat. Nos. 5,612,175 and 5,614,359; and Irving et al U.S. Pat. No. 5,667,954.

Ultrathin high bromide {111} tabular grain emulsions are illustrated by Daubendiek et al U.S. Pat. Nos. 4,672,027; 4,693,964; 5,494,789; 5,503,971; and 5,576,168; Antoniades et al U.S. Pat. No. 5,250,403; Olm et al U.S. Pat. No. 5,503,970; Deaton et al U.S. Pat. No. 5,582,965; and Maskasky U.S. Pat. No. 5,667,955. High bromide {100} tabular grain emulsions are illustrated by Mignot U.S. Pat. Nos. 4,386,156 and 5,386,156.

High chloride {111} tabular grain emulsions are illustrated by Wey U.S. Pat. No. 4,399,215; Wey et al U.S. Pat. No. 4,414,306; Maskasky U.S. Pat. Nos. 4,400,463; 4,713,323; 5,061,617; 5,178,997; 5,183,732; 5,185,239; 5,399,478; and 5,411,852; and Maskasky et al U.S. Pat. Nos. 5,176,992 and 5,178,998. Ultrathin high chloride {111} tabular grain emulsions are illustrated by Maskasky U.S. Pat. Nos. 5,271,858 and 5,389,509.

High chloride {100} tabular grain emulsions are illustrated by Maskasky U.S. Pat. Nos. 5,264,337; 5,292,632; 5,275,930; and 5,399,477; House et al U.S. Pat. No. 5,320,938; Brust et al U.S. Pat. No. 5,314,798; Szajewski et al U.S. Pat. No. 5,356,764; Chang et al U.S. Pat. Nos. 5,413,904 and 5,663,041; Oyamada U.S. Pat. No. 5,593,821; Yamashita et al U.S. Pat. Nos. 5,641,620 and 5,652,088; Saitou et al U.S. Pat. No. 5,652,089; and Oyamada et al U.S. Pat. No. 5,665,530. Ultrathin high chloride {100} tabular grain emulsions can be prepared by nucleation in the presence of iodide, following the teaching of House et al and Chang et al, cited above.

The emulsions can be surface-sensitive emulsions, i.e., emulsions that form latent images primarily on the surfaces of the silver halide grains, or the emulsions can form internal latent images predominantly in the interior of the silver halide grains. The emulsions can be negative-working emulsions, such as surface-sensitive emulsions or unfogged internal latent image-forming emulsions, or direct-positive emulsions of the unfogged, internal latent image-forming type, which are positive-working when development is conducted with uniform light exposure or in the presence of a nucleating agent. Negative working emulsions are preferred.

The silver halide layer may also contain a dye image forming coupler. Coupling-off groups are well known in the art. Such groups can determine the chemical equivalency of a coupler, i.e., whether it is a 2-equivalent or a 4-equivalent coupler, or modify the reactivity of the coupler. Such groups can advantageously affect the layer in which the coupler is coated, or other layers in the photographic recording material, by performing, after release from the coupler, functions such as dye formation, dye hue adjustment, development acceleration or inhibition, bleach acceleration or inhibition, electron transfer facilitation, and color correction.

The presence of hydrogen at the coupling site provides a 4-equivalent coupler, and the presence of another coupling-off group usually provides a 2-equivalent coupler. Representative classes of such coupling-off groups include, for example, chloro, alkoxy, aryloxy, hetero-oxy, sulfonyloxy, acyloxy, acyl, heterocyclyl, sulfonamido, mercaptotetrazole, benzothiazole, mercaptopropionic acid, phosphonyloxy, arylthio, and arylazo. These coupling-off groups are described in the art, for example, in U.S. Pat. Nos. 2,455,169; 3,227,551; 3,432,521; 3,476,563; 3,617,291; 3,880,661; 4,052,212; and 4,134,766; and in UK. Patents and published application Nos. 1,466,728; 1,531,927; 1,533,039; 2,006,755A and 2,017,704A, the disclosures of which are incorporated herein by reference.

Image dye-forming couplers may be included in the element such as couplers that form cyan dyes upon reaction with oxidized color developing agents which are described in such representative patents and publications as: “Farbkuppler-eine Literature Ubersicht,” published in Agfa Mitteilungen, Band III, pp. 156-175 (1961) as well as in U.S. Pat. Nos. 2,367,531; 2,423,730; 2,474,293; 2,772,162; 2,895,826; 3,002,836; 3,034,892; 3,041,236; 4,333,999; 4,746,602; 4,753,871; 4,770,988; 4,775,616; 4,818,667; 4,818,672; 4,822,729; 4,839,267; 4,840,883; 4,849,328; 4,865,961; 4,873,183; 4,883,746; 4,900,656; 4,904,575; 4,916,051; 4,921,783; 4,923,791; 4,950,585; 4,971,898; 4,990,436; 4,996,139; 5,008,180; 5,015,565; 5,011,765; 5,011,766; 5,017,467; 5,045,442; 5,051,347; 5,061,613; 5,071,737; 5,075,207; 5,091,297; 5,094,938; 5,104,783; 5,178,993; 5,813,729; 5,187,057; 5,192,651; 5,200,305; 5,202,224; 5,206,130; 5,208,141; 5,210,011; 5,215,871; 5,223,386; 5,227,287; 5,256,526; 5,258,270; 5,272,051; 5,306,610; 5,326,682; 5,366,856; 5,378,596; 5,380,638; 5,382,502; 5,384,236; 5,397,691; 5,415,990; 5,434,034; 5,441,863; EPO 0 246 616; EPO 0 250 201; EPO 0 271 323; EPO 0 295 632; EPO 0 307 927; EPO 0 333 185; EPO 0 378 898; EPO 0 389 817; EPO 0 487 111; EPO 0488 248; EPO 0539 034; EPO 0 545 300; EPO 0 556 700; EPO 0 556 777; EPO 0 556 858; EPO 0 569 979; EPO 0 608 133; EPO 0 636 936; EPO 0 651 286; EPO 0 690 344; German OLS 4,026,903; German OLS 3,624,777 and German OLS 3,823,049. Typically such couplers are phenyls, naphthols, or pyrazoloazoles.

Couplers that form magenta dyes upon reaction with oxidized color developing agent are described in such representative patents and publications as: “Farbkuppler-eine Literature Ubersicht,” published in Agfa Mitteilungen, Band III, pp. 126-156 (1961) as well as U.S. Pat. Nos. 2,311,082 and 2,369,489; 2,343,701; 2,600,788; 2,908,573; 3,062,653; 3,152,896; 3,519,429; 3,758,309; 3,935,015; 4,540,654; 4,745,052; 4,762,775; 4,791,052; 4,812,576; 4,835,094; 4,840,877; 4,845,022; 4,853,319; 4,868,099; 4,865,960; 4,871,652; 4,876,182; 4,892,805; 4,900,657; 4,910,124; 4,914,013; 4,921,968; 4,929,540; 4,933,465; 4,942,116; 4,942,117; 4,942,118; U.S. Pat. Nos. 4,959,480; 4,968,594; 4,988,614; 4,992,361; 5,002,864; 5,021,325; 5,066,575; 5,068,171; 5,071,739; 5,100,772; 5,110,942; 5,116,990; 5,118,812; 5,134,059; 5,155,016; 5,183,728; 5,234,805; 5,235,058; 5,250,400; 5,254,446; 5,262,292; 5,300,407; 5,302,496; 5,336,593; 5,350,667; 5,395,968; 5,354,826; 5,358,829; 5,368,998; 5,378,587; 5,409,808; 5,411,841; 5,418,123; 5,424,179; EPO 0 257 854; EPO 0 284 240; EPO 0 341 204; EPO 347,235; EPO 365,252; EPO 0 422 595; EPO 0 428 899; EPO 0 428 902; EPO 0459 331; EPO 0467 327; EPO 0476 949; EPO 0487 081; EPO 0 489 333; EPO 0 512 304; EPO 0 515 128; EPO 0 534 703; EPO 0 554 778; EPO 0 558 145; EPO 0 571 959; EPO 0 583 832; EPO 0 583 834; EPO 0 584 793; EPO 0 602 748; EPO 0 602 749; EPO 0 605 918; EPO 0 622 672; EPO 0 622 673; EPO 0 629 912; EPO 0 646 841, EPO 0 656 561; EPO 0 660 177; EPO 0 686 872; WO 90/10253; WO 92/09010; WO 92/10788; WO 92/12464; WO 93/01523; WO 93/02392; WO 93/02393; WO 93/07534; UK Application 2,244,053; Japanese Application 03192-350; German OLS 3,624,103; German OLS 3,912,265; and German OLS 40 08 067. Typically such couplers are pyrazolones, pyrazoloazoles, or pyrazolobenzimidazoles that form magenta dyes upon reaction with oxidized color developing agents.

Couplers that form yellow dyes upon reaction with oxidized color developing agent are described in such representative patents and publications as: “Farbkuppler-eine Literature Ubersicht,” published in Agfa Mitteilungen; Band III; pp. 112-126 (1961); as well as U.S. Pat. Nos. 2,298,443; 2,407,210; 2,875,057; 3,048,194; 3,265,506; 3,447,928; 4,022,620; 4,443,536; 4,758,501; 4,791,050; 4,824,771; 4,824,773; 4,855,222; 4,978,605; 4,992,360; 4,994,361; 5,021,333; 5,053,325; 5,066,574; 5,066,576; 5,100,773; 5,118,599; 5,143,823; 5,187,055; 5,190,848; 5,213,958; 5,215,877; 5,215,878; 5,217,857; 5,219,716; 5,238,803; 5,283,166; 5,294,531; 5,306,609; 5,328,818; 5,336,591; 5,338,654; 5,358,835; 5,358,838; 5,360,713; 5,362,617; 5,382,506; 5,389,504; 5,399,474; 5,405,737; 5,411,848; 5,427,898; EPO 0 327 976; EPO 0296 793; EPO 0365 282; EPO 0 379 309; EPO 0415 375; EPO 0437 818; EPO 0447 969; EPO 0 542 463; EPO 0 568 037; EPO 0 568 196; EPO 0 568 777; EPO 0 570 006; EPO 0 573 761; EPO 0 608 956; EPO 0 608 957; and EPO 0 628 865. Such couplers are typically open chain ketomethylene compounds.

Couplers that form black dyes upon reaction with oxidized color developing agent are described in such representative patents as U.S. Pat. Nos. 1,939,231; 2,181,944; 2,333,106; and 4,126,461; German OLS No. 2,644,194 and German OLS No. 2,650,764. Typically, such couplers are resorcinols or m-aminophenyls that form black or neutral products on reaction with oxidized color developing agent.

It may be useful to use a combination of couplers any of which may contain known ballasts or coupling-off groups such as those described in U.S. Pat. Nos. 4,301,235; 4,853,319; and 4,351,897. The coupler may contain solubilizing groups such as described in U.S. Pat. No. 4,482,629.

Typically, couplers are incorporated in a silver halide emulsion layer in a mole ratio to silver of 0.05 to 1.0 and generally 0.1 to 0.5. Usually the couplers are dispersed in a high-boiling organic solvent in a weight ratio of solvent to coupler of 0.1 to 10.0 and typically 0.1 to 2.0, although dispersions using no permanent coupler solvent are sometimes employed.

In one embodiment the silver halide is chemically sensitized. The photographic emulsions of this invention are generally prepared by precipitating silver halide crystals in a colloidal matrix by methods conventional in the art. The colloid is typically a hydrophilic film forming agent such as gelatin, alginic acid, or derivatives thereof.

The crystals formed in the precipitation step are washed and then may be chemically sensitized by adding chemical sensitizers, and, in some cases by providing a heating step during which the emulsion temperature is raised, typically from 40° C. to 70° C., and maintained for a period of time. The precipitation and chemical sensitization methods utilized in preparing the emulsions employed in the invention can be those methods known in the art.

Chemical sensitization of the emulsion typically employs sensitizers such as sulfur-containing compounds, e.g., allyl isothiocyanate, sodium thiosulfate and allyl thiourea; reducing agents, e.g., polyamines and stannous salts; noble metal compounds, e.g., gold, platinum; and polymeric agents, e.g., polyalkylene oxides. As described, heat treatment is preferably employed to complete chemical sensitization. After sensitization, the emulsion is coated on a support. Various coating techniques include dip coating, air knife coating, curtain coating, and extrusion coating.

In the following discussion of suitable materials for use in the emulsions and elements of this invention, reference will be made to Research Disclosure, September 1996, Item 38957, available as described above, which is referred to herein by the term “Research Disclosure”. The contents of the Research Disclosure, including the patents and publications referenced therein, are incorporated herein by reference, and the Sections hereafter referred to are Sections of the Research Disclosure.

Suitable emulsions and their preparation as well as methods of chemical sensitization are described in Sections I through V. Various additives such as UV dyes, brighteners, antifoggants, stabilizers, light absorbing and scattering materials, and physical property modifying addenda such as hardeners, coating aids, plasticizers, lubricants and matting agents are described, for example, in Sections II and VI through VIII. Color materials are described in Sections X through XIII. Suitable methods for incorporating couplers and dyes, including dispersions in organic solvents, are described in Section X(E). Supports, exposure, development systems, and processing methods and agents are described in Sections XV to XX. The information contained in the September 1994 Research Disclosure, Item No. 36544 referenced above, is updated in the September 1996 Research Disclosure, Item No. 38957. Certain desirable photographic elements and processing steps, including those useful in conjunction with color reflective prints, are described in Research Disclosure, Item 37038, February 1995.

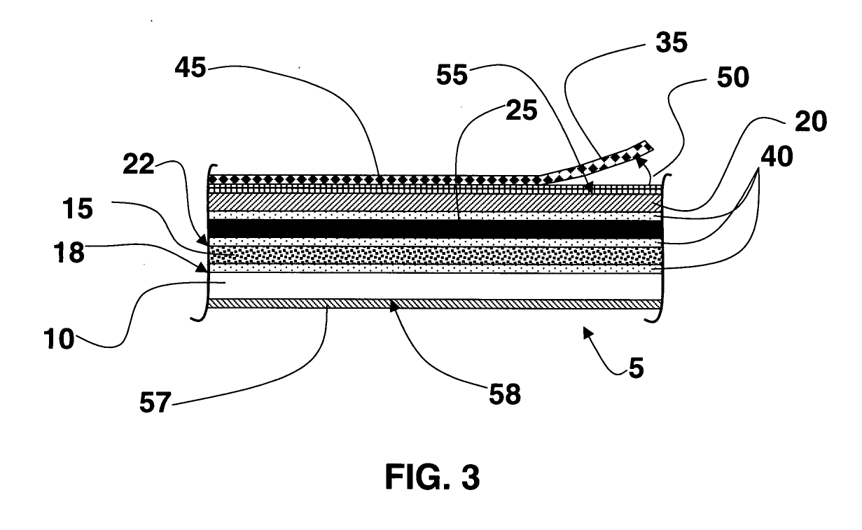

The support to be utilized is preferably opaque. In some instances, however, the support may be transparent in which case an additional blocking layer 57 shown in FIG. 3 may be coated on the bottom surface 58 of the support 10. The support may comprise any of the materials known in the art. The support can be a flexible substrate. Examples of supports useful for practice of the invention are resin-coated paper, paper, polyesters, or micro porous materials such as polyethylene polymer-containing material sold by PPG Industries, Inc., Pittsburgh, Pa. under the trade name of Teslin®, Tyvek® synthetic paper (DuPont Corp.), and OPPalyte® films (Mobil Chemical Co.) and other composite films listed in U.S. Pat. No. 5,244,861. Opaque supports include plain paper, coated paper, synthetic paper, photographic paper support, melt-extrusion-coated paper, and laminated paper, such as biaxially oriented support laminates. Biaxially oriented support laminates are described in U.S. Pat. Nos. 5,853,965; 5,866,282; 5,874,205; 5,888,643; 5,888,681; 5,888,683; and 5,888,714, the disclosures of which are hereby incorporated by reference. These biaxially oriented supports include a paper base and a biaxially oriented polyolefin sheet, typically polypropylene, laminated to one or both sides of the paper base. Transparent supports include glass, cellulose derivatives, e.g., a cellulose ester, cellulose triacetate, cellulose diacetate, cellulose acetate propionate, cellulose acetate butyrate; polyesters, such as poly(ethylene terephthalate), poly(ethylene naphthalate), poly(1,4-cyclohexanedimethylene terephthalate), poly(butylene terephthalate), and copolymers thereof; polyimides; polyamides; polycarbonates; polystyrene; polyolefins, such as polyethylene or polypropylene; polysulfones; polyacrylates; polyether imides; and mixtures thereof. The papers listed above include a broad range of papers, from high end papers, such as photographic paper to low end papers, such as newsprint. Another example of supports useful for practice of the invention are fabrics such as wools, cotton, polyesters, etc. The multilayer medium 5 may be, for example, in the form of a web or a sheet. In one preferred embodiment the support is a film type material, particularly useful may be poly(ethylene terephthalate).

The sensor can contain additional layers, such as filter layers, interlayers, overcoat layers, subbing layers, and the like. The filter layer could be coated above the sampling layer to prevent interference materials from reaching the sampling layer or above the amplification layer to prevent interference materials from reaching the amplification layer, i.e., allowing only the signal compound to reach the amplification layer. Now referring to FIG. 3, there illustrates a cross section of yet another embodiment the multilayer sensor 5 of FIG. 1 made in accordance with the present invention. In the embodiment illustrated in FIG. 3 the sensor 5 comprises a removable protective layer 35 over the sampling layer 20. In some instances an additional release layer 45 may be required between the removable protective layer 35 and the sampling layer 20. Depending upon the material chosen for the support layer 10, an additional layer called a subbing layer 40 may be coated on the top surface 18 of the support layer 10. The subbing layer 40 is used to insure proper adhesion of the amplification layer 15 to the support layer 10. Likewise the subbing layer 40 maybe coated on the top surface 22 of the amplification layer 15. The subbing layer 40 is used to insure proper adhesion of a blocking layer 25 to the amplification layer 15. As previously discussed depending on what material is used for the base 10, the amplification layer 15 and the blocking layer 25 the subbing layer 40 may or may not be required. The addition of a subbing layer may or may not be required between any the adjacent layers of the multilayer sensor 5. Preparing a support surface (hydrophobic) such as polyvinyl alcohol to accept a solvent cast polymer such as cellulose triacetate would require chemical and/or an interlayer coating (subbing layer) to improve adhesion. An example of this could be found in photographic patent literature where gelatin based hydrophilic photographic materials are commonly attached to hydrophobic supports such as polyethylene terephthalate.

In the embodiment illustrated in FIG. 3, an optional peelable protective release layer 45 is provided over the sampling layer 20 for protecting the sampling layer 20 until the sensor 5 is to be used for testing. The release layer 45 is peeled off the sampling layer 20 as indicated by arrow 50 exposing the top surface 55 of the sampling layer 20.

In one embodiment the sensor can detect more than one type of contaminant. In one suitable embodiment the sampling layer would be striped (not shown) with each stripe being sensitive to a different target species. As can be appreciated, a variety of different elements, depending on the analysis of choice, can be prepared in accordance with the present invention. Sensors can be configured in a variety of forms, including elongated tapes of any desired width, sheets or smaller chips. As noted above, test strips are particularly contemplated.

In the case of the agricultural sensor, for example, the food is swabbed for suspected contamination. The swab is applied to the sensor. At very low concentrations, the sampling layer would release chemistry (e.g., free radicals) that would diffuse to the silver halide layer, causing a latent image. This latent image is amplified when the sensor is either developed by a triggerable chemistry, or with heat. The silver halide may form a black and white image or the development of the silver may result in chemistry which develops uncolored compounds (known as couplers) to colored dyes. The colors are observed and recorded. They can be “stopped” or “fixed” at any point, can be scanned for density to obtain a quantitative number, and can be stored or catalogued for later use (confirmation, verification, audit, etc.).

Black and white processing methods are well known in the art. Black-and-white developing compositions contain one or more black-and-white developing agents, including dihydroxybenzene and derivatives thereof and ascorbic acid and derivatives thereof. Dihydroxybenzene and similar developing agents include hydroquinone and other derivatives readily apparent to one skilled in the art [see, for example, U.S. Pat. No. 4,269,929 (Nothnagle) and U.S. Pat. No. 5,457,011 (Lehr et al)]. Hydroquinone is generally preferred. “Ascorbic acid” developing agents are described in numerous publications including U.S. Pat. No. 5,236,816 (noted above) and references cited therein. Useful ascorbic acid developing agents include ascorbic acid and the analogues, isomers and derivatives thereof. Such compounds include, but are not limited to, D- or L-ascorbic acid, sugar-type derivatives thereof (such as sorboascorbic acid, γ-lactoascorbic acid, 6-desoxy-L-ascorbic acid, L-rhamnoascorbic acid, imino-6-desoxy-L-ascorbic acid, glucoascorbic acid, fucoascorbic acid, glucoheptoascorbic acid, maltoascorbic acid, L-arabosascorbic acid), sodium ascorbate, potassium ascorbate, isoascorbic acid (or L-erythroascorbic acid), and salts thereof (such as alkali metal, ammonium or others known in the art), endiol type ascorbic acid, an enaminol type ascorbic acid, a thioenol type ascorbic acid, and an enamin-thiol type ascorbic acid, as described for example in U.S. Pat. No. 5,498,511 (Yamashita et al), EP-A-0 585,792 (published Mar. 9, 1994), EP-A-0 573 700 (published Dec. 15, 1993), EP-A-0 588 408 (published Mar. 23, 1994), WO 95/00881 (published Jan. 5, 1995), U.S. Pat. Nos. 5,089,819 and 5,278,035 (both of Knapp), U.S. Pat. No. 5,384,232 (Bishop et al), U.S. Pat. No. 5,376,510 (Parker et al), Japanese Kokai 7-56286 (published Mar. 3, 1995), U.S. Pat. No. 2,688,549 (James et al), U.S. Pat. No. 5,236,816 (noted above) and Research Disclosure, publication 37152, Mar. 1995. D-, L-, or D,L-ascorbic acid (and alkali metal salts thereof) or isoascorbic acid (or alkali metal salts thereof) are preferred. Sodium ascorbate and sodium isoascorbate are most preferred. Mixtures of these developing agents can be used if desired.

Useful black-and-white developing compositions also preferably include one or more auxiliary co-developing agents that are also well known (for example, Mason, Photographic Processing Chemistry, Focal Press, London, 1975). Any auxiliary developing agent can be used, but the 3-pyrazolidone developing agents are preferred (also known as “phenidone” type developing agents). Such compounds are described, for example, in U.S. Pat. No. 5,236,816 (noted above). The most commonly used compounds of this class are 1-phenyl-3-pyrazolidone, 1-phenyl-4,4-dimethyl-3-pyrazolidone, 4-hydroxymethyl-4-methyl-1-phenyl-3-pyrazolidone, 5-phenyl-3-pyrazolidone, 1-p-aminophenyl-4,4-dimethyl-3-pyrazolidone, 1-p-tolyl-4,4-dimethyl-3-pyrazolidone, 1-p-tolyl-4-hydroxymethyl-4-methyl-3-pyrazolidone, and 1-phenyl-4,4-dihydroxymethyl-3-pyrazolidone. Other useful auxiliary co-developing agents comprise one or more solubilizing groups, such as sulfo, carboxy or hydroxy groups attached to aliphatic chains or aromatic rings, and preferably attached to the hydroxymethyl function of a pyrazolidone, as described, for example, in U.S. Pat. No. 5,837,434 (Roussilhe et al). A most preferred auxiliary co-developing agent is 4-hydroxymethyl-4-methyl-1-phenyl-3-pyrazolidone. Less preferred auxiliary co-developing agents include aminophenyls such as p-aminophenyl, o-aminophenyl, N-methylaminophenyl, 2,4-diaminophenyl hydrochloride, N-(4-hydroxyphenyl)glycine, p-benzylaminophenyl hydrochloride, 2,4-diamino-6-methylphenyl, 2,4-diaminoresorcinol and N-(β-hydroxyethyl)-p-aminophenyl. A mixture of different types of auxiliary developing agents can also be used if desired.

Useful black and white developers also preferably include one or more preservatives or antioxidants. Various organic preservatives, such as hydroxylamine and alkyl- or aryl-derivatives thereof, can be used, and inorganic preservatives such as sulfites can be used. Sulfites are preferred. A “sulfite” preservative is used herein to mean any sulfur compound that is capable of forming or providing sulfite ions in aqueous alkaline solution. Examples include, but are not limited to, alkali metal sulfites, alkali metal bisulfites, alkali metal metabisulfites, amine sulfur dioxide complexes, sulfurous acid and carbonyl-bisulfite adducts. Mixtures of these materials can also be used. Examples of preferred sulfites include sodium sulfite, potassium sulfite, lithium sulfite, sodium bisulfite, potassium bisulfite, sodium metabisulfite, potassium metabisulfite, and lithium metabisulfite. The carbonyl-bisulfite adducts that are useful include alkali metal or amine bisulfite adducts of aldehydes and bisulfite adducts of ketones. Examples of these compounds include sodium formaldehyde bisulfite, sodium acetaldehyde bisulfite, succinaldehyde bis-sodium bisulfite, sodium acetone bisulfite, β-methyl glutaraldehyde bis-sodium bisulfite, sodium butanone bisulfite, and 2,4-pentandione bis-sodium bisulfite.

Various known buffers, such as borates, carbonates and phosphates, or combinations of any of these can also be included in the developer to maintain the desired pH when in aqueous form. The pH can be adjusted with a suitable base (such as a hydroxide) or acid. Optionally, the black-and-white developers contain one or more sequestering agents that typically function to form stable complexes with free metal ions or trace impurities (such as silver, calcium, iron, and copper ions) in solution that may be introduced into the developing composition in a number of ways. The sequestering agents, individually or in admixture, are present in conventional amounts. Many useful sequestering agents are known in the art, but particularly useful classes of compounds include, but are not limited to, multimeric carboxylic acids, polyphosphonic acids and polyaminophosphonic acids, and any combinations of these classes of materials as described in U.S. Pat. No. 5,389,502 (Fitterman et al), aminopolycarboxylic acids and polyphosphate ligands. Representative sequestering agents include ethylenediaminetetraacetic acid, diethylenetriaminepentaacetic acid, 1,3-propylenediaminetetraacetic acid, 1,3-diamino-2-propanoltetraacetic acid, ethylenediaminodisuccinic acid, ethylenediaminomonosuccinic acid, 4,5-dihydroxy-1,3-benzenedisulfonic acid, disodium salt (TIRON®), N,N′-1,2-ethanediylbis {N-[(2-hydroxyphenyl) methyl]} glycine (“HBED”), N {2-[bis(carboxymethyl)amino]ethyl}-N-(2-hydroxyethyl)glycine (“HEDTA”), N-{2-[bis(carboxymethyl)amino]ethyl}-N-(2-hydroxyethyl)glycine, trisodium salt (available as VERSENOL® from Acros Organics, Sigma Chemical or Callaway Chemical), and 1-hydroxyethylidenediphosphonic acid (available as DEQUEST® 2010 from Solutia Co.).

The black-and-white developers can also contain other additives including various development restrainers, development accelerators, swelling control agents, dissolving aids, surface active agents, colloid dispersing aids, solubilizing solvents (such as glycols and alcohols), restrainers (such as sodium or potassium bromide), and sludge control agents (such as 2-mercaptobenzothiazole, 1,2,4-triazole-3-thiol, 2-benzoxazolethiol and 1-phenyl-5-mercatoetrazole), each in conventional amounts. Examples of such optional components are described in U.S. Pat. Nos. 5,236,816 (noted above), 5,474,879 (Fitterman et al), 5,837,434 (Roussilhe et al), Japanese Kokai 7-56286 and EP-A-0 585 792. The black-and-white developers can also include one or more photographic fixing agents (described below) to provide what is known in the art as “monobaths”.

In most processing methods in which a developing composition is used, its use is generally followed by a fixing step using a photographic fixing composition containing a photographic fixing agent. While sulfite ion sometimes acts as a fixing agent, the fixing agents generally used are thiosulfates (including sodium thiosulfate, ammonium thiosulfate, potassium thiosulfate and others readily known in the art), cysteine (and similar thiol containing compounds), mercapto-substituted compounds (such as those described by Haist, Modern Photographic Processing, John Wiley & Sons, N.Y., 1979), thiocyanates (such as sodium thiocyanate, potassium thiocyanate, ammonium thiocyanate and others readily known in the art), amines or halides. Mixtures of one or more of these classes of photographic fixing agents can be used if desired. Thiosulfates and thiocyanates are preferred. In a some embodiments, a mixture of a thiocyanate (such as sodium thiocyanate) and a thiosulfate (such as sodium thiosulfate) is used. In such mixtures, the molar ratio of a thiosulfate to a thiocyanate is from about 1:1 to about 1:10, and preferably from about 1:1 to about 1:2. The sodium salts of the fixing agents are preferred for environmental advantages. The fixing composition can also include various addenda commonly employed therein, such as buffers, fixing accelerators, sequestering agents, swelling control agents, and stabilizing agents, each in conventional amounts. In its aqueous form, the fixing composition generally has a pH of at least 4, preferably at least 4.5, and generally less than 6, and preferably less than 5.5.

In black-and-white processing development and fixing are preferably, but not essentially, followed by a suitable washing step to remove silver salts dissolved by fixing and excess fixing agents, and to reduce swelling in the element. The wash solution can be water, but preferably the wash solution is acidic, and more preferably, the pH is 7 or less, and preferably from about 4.5 to about 7, as provided by a suitable chemical acid or buffer. After washing, the processed elements may be dried for suitable times and temperatures, but in some instances the black-and-white images may be viewed in a wet condition.

Means of black and white processing for the sensors are similar to processing black and white photographic elements. For example, the exposure and processing techniques of U.S. Pat. Nos. 5,021,327 (Bunch et al.) and 5,576,156 (Dickerson), are typical for processing radiographic films. Other processing compositions (both developing and fixing compositions) are described in Fitterman et al U.S. Pat. Nos. 5,738,979; 5,866,309; 5,871,890; 5,935,770; and 5,942,378, all incorporated herein by reference. Such processing can be carried out in any suitable processing equipment including but not limited to, a modified Kodak X-OMAT® RA 480 type processor that can utilize Kodak Rapid Access processing chemistry. Other “rapid access processors” are described for example in U.S. Pat. No. 3,545,971 (Barnes e al) and EP-A-0 248,390 (Akio et al).

The sensors can be used in both what are known as “slow access” and “rapid access” processing methods and equipment. For example, black-and-white motion picture films, industrial radiographic films and professional films and papers are generally developed over a longer period of time (for example, for at least 1 minute and up to 12 minutes). Total processing including other steps (for example fixing and washing) would be even longer. Preferably a rapid access method would be utilized.

“Rapid-access” methods are generally used to process medical radiographic X-ray films, graphic arts films and microfilms and development may be at least 10 seconds and up to 60 seconds (preferably from about 10 to about 30 seconds). The total processing time (for example including fixing and washing) is as short as possible, but generally from about 20 to about 120 seconds. An example of a “rapid access” system is that commercially available as the KODAK RP X-OMAT® processing system that also includes a conventional photographic fixing composition. For either type of processing method, the development temperature can be any temperature within a wide range as known by one skilled in the art, for example from about 15 to about 50° C.

The above sensor could be chemically developed utilizing known color developing methods such as color negative (Kodak C-41), color print (Kodak RA-4), or reversal (Kodak E-6) process. The Kodak C-41 process is described in The British Journal of Photography Annual of 1988, pages 191-198. The Kodak ECN-2 process is described in the H-24 Manual available from Eastman Kodak Co. and may be employed to provide a color negative image on a transparent support. Color negative development times are typically 3′ 15″ or less and desirably 90 or even 60 seconds or less. The Kodak RA-4 process is generally described in PCT WO 87/04534 or U.S. Pat. No. 4,975,357. The Kodak ECP-2 process, normally utilized for color projection prints, is described in the H-24 Manual. Color print development times are typically 90 seconds or less and desirably 45 or even 30 seconds or less. Color print processes are particularly useful for high chloride emulsions.

Another type of color negative element is a color reversal element is capable of forming a positive image without optical printing. To provide a positive (or reversal) image, the color development step is preceded by development with a non-chromogenic developing agent to develop exposed silver halide, but not form dye, and followed by uniformly fogging the element to render unexposed silver halide developable. Such reversal elements are typically developed using a color reversal process such as the Kodak E-6 process as described in The British Journal of Photography Annual of 1988, page 194.

Preferred color developing agents arep-phenylenediamines such as:
4-amino-N,N-diethylaniline hydrochloride,
4-amino-3-methyl-N,N-diethylaniline hydrochloride,
4-amino-3-methyl-N-ethyl-N-(2-methanesulfonamidoethyl)aniline sesquisulfate hydrate,
4-amino-3-methyl-N-ethyl-N-(2-hydroxyethyl)aniline sulfate,
4-amino-3-(2-methanesulfonamidoethyl)-N,N-diethylaniline hydrochloride, and
4-amino-N-ethyl-N-(2-methoxyethyl)-m-toluidine di-p-toluene sulfonic acid.

Development is usually followed by the conventional steps of bleaching, fixing, or bleach-fixing, to remove silver or silver halide, washing, and drying. The steps of fixing, washing, or drying may be added as needed to produce a permanent record in the sensor, or may be eliminated if it does not interfere with measuring the sensors response, and no permanent record is desired.

Another method of development involves the use of heat with a thermally sensitive silver emulsion similar to a photothermographic material. If the sensor is to be heat developed the silver halide amplification layer will generally comprise silver halide that upon LIFCS exposure provides a latent image in exposed grains that are capable of acting as a catalyst for the subsequent formation of a silver image in a development step, (b) a non-LIFCS sensitive source of reducible silver ions, (c) a reducing composition (usually including a developer) for the reducible silver ions, and (d) a hydrophilic or hydrophobic binder. The latent image is then developed by application of thermal energy.

In such materials, the silver halide is considered to be in catalytic proximity to the non-LIFCS sensitive source of reducible silver ions. Catalytic proximity requires intimate physical association of these two components either prior to or during the thermal image development process so that when silver atoms (Ag⁰)ₙ, also known as silver specks, clusters, nuclei or latent image, are generated by LIFCS exposure of the photosensitive silver halide, those silver atoms are able to catalyze the reduction of the reducible silver ions within a catalytic sphere of influence around the silver atoms [D. H. Klosterboer, Imaging Processes and Materials, (Neblette's Eighth Edition), J. Sturge, V. Walworth, and A. Shepp, Eds., Van Nostrand-Reinhold, New York, 1989, Chapter 9, pp. 279-291]. It has long been understood that silver atoms act as a catalyst for the reduction of silver ions, and that the latent image forming silver halide can be placed in catalytic proximity with the non-LIFS sensitive source of reducible silver ions in a number of different ways (see, for example, Research Disclosure, June 1978, item 17029) “Catalytic proximity” or “reactive association” means that the materials are in the same layer or in adjacent layers so that they readily come into contact with each other during thermal imaging and development.

The construction of the silver halide amplification layer may be one layer or sublayers wherein the LIFCS sensitive silver halide and the source of reducible silver ions are in one layer and the other essential components or desirable additives are distributed, as desired, in the same layer or in an adjacent coating layer. These materials also include sublayer constructions in which one or more imaging components are in different layers, but are in “reactive association” so that they readily come into contact with each other during imaging and/or development. For example, one sublayer can include the non-LIFCS sensitive source of reducible silver ions and another sublayer can include the reducing composition, but the two reactive components are in reactive association with each other.

As used herein, the phrase “organic silver coordinating ligand” refers to an organic molecule capable of forming a bond with a silver atom. Although the compounds so formed are technically silver coordination compounds they are also often referred to as silver salts.

As noted above, the thermally developed materials of the present invention include one or more silver halides in the thermally developed emulsion layer(s). Useful silver halides are typically LIFCS sensitive silver halides such as silver bromide, silver iodide, silver chloride, silver bromoiodide, silver chlorobromoiodide, and silver chlorobromide such as described above. In preferred embodiments for use in thermal development, the silver halide comprises at least 70 mol % silver bromide with the remainder being silver chloride and silver iodide. More preferably, the amount of silver bromide is at least 90 mol %. Silver bromide and silver bromoiodide are more preferred silver halides, with the latter silver halide having up to 10 mol % silver iodide based on total silver halide. Typical techniques for preparing and precipitating silver halide grains are described in Research Disclosure, 1978, item 17643. Research Disclosure is a publication of Kenneth Mason Publications Ltd., Dudley House, 12 North Street, Emsworth, Hampshire PO10 7DQ England (also available from Emsworth Design Inc., 147 West 24th Street, New York, N.Y 10011).

In some embodiments of aqueous-based thermally developable materials, higher amounts of iodide may be present in the LIFCS silver halide grains, and particularly from about 20 mol % up to the saturation limit of iodide, to increase image stability and to reduce “print-out,” as described, for example, in copending and commonly assigned U.S. Ser. No. 10/246,265 (filed Sep. 18, 2002 by Maskasky and Scaccia).

The shape of the LIFCS silver halide grains used in this embodiment of the present invention is in no way limited as noted above. The silver halide grains may have any crystalline habit including, but not limited to, cubic, octahedral, tetrahedral, orthorhombic, rhombic, dodecahedral, other polyhedral, tabular, laminar, twinned, or platelet morphologies and may have epitaxial growth of crystals thereon. If desired, a mixture of these crystals can be employed. Silver halide grains having cubic and tabular morphology are preferred.

The silver halide grains may have a uniform ratio of halide throughout. They may have a graded halide content, with a continuously varying ratio of, for example, silver bromide and silver iodide or they may be of the core-shell type, having a discrete core of one halide ratio, and a discrete shell of another halide ratio. For example, the central regions of the tabular grains may contain at least 1 mol % more iodide than the outer or annular regions of the grains. Core-shell silver halide grains useful in thermally developed materials and methods of preparing these materials are described for example in U.S. Pat. No. 5,382,504 (Shor et al), incorporated herein by reference. Iridium and/or copper doped core-shell and non-core-shell grains are described in U.S. Pat. No. 5,434,043 (Zou et al) and U.S. Pat. No. 5,939,249 (Zou), both incorporated herein by reference. Mixtures of preformed silver halide grains having different compositions or dopants grains may be employed.

The LIFCS silver halide can be added to (or formed within) the emulsion layer(s) in any fashion as long as it is placed in catalytic proximity to the non-LIFCS sensitive source of reducible silver ions. It is preferred that the silver halide grains be preformed and prepared by an ex-situ process. The silver halide grains prepared ex-situ may then be added to and physically mixed with the non-LIFCS source of reducible silver ions.

In some formulations it is useful to form the source of reducible silver ions in the presence of ex-situ-prepared silver halide. In this process, the source of reducible silver ions, such as a long chain fatty acid silver carboxylate (commonly referred to as a silver “soap”), is formed in the presence of the preformed silver halide grains. Co-precipitation of the reducible source of silver ions in the presence of silver halide provides a more intimate mixture of the two materials [see, for example U.S. Pat. No. 3,839,049 (Simons)]. Materials of this type are often referred to as “preformed soaps.”

In general, the non-tabular silver halide grains used in the imaging formulations can vary in average diameter of up to several micrometers (μm) depending on their desired use. Usually, the silver halide grains have an average particle size of from about 0.01 to about 1.5 μm. In some embodiments, the average particle size is preferable from about 0.03 to about 1.0 μm, and more preferably from about 0.05 to about 0.8 μm.

The average size of the doped LIFCS silver halide grains is expressed by the average diameter if the grains are spherical, and by the average of the diameters of equivalent circles for the projected images if the grains are cubic, tabular, or other non-spherical shapes. In further embodiments of this invention, the silver halide grains are tabular silver halide grains that are considered “ultrathin” and have an average thickness of at least 0.02 μm and up to and including 0.10 μm. Preferably, these ultrathin grains have an average thickness of at least 0.03 μm and more preferably of at least 0.04 μm, and up to and including 0.08 μm and more preferably up to and including 0.07 μm. In addition, these ultrathin tabular grains have an equivalent circular diameter (ECD) of at least 0.5 μm, preferably at least 0.75 μm, and more preferably at least 1 μm. The ECD can be up to and including 8 μm, preferably up to and including 6 μm, and more preferably up to and including 4 μm. The aspect ratio of the useful tabular grains is at least 5:1, preferably at least 10:1, and more preferably at least 15:1. For practical purposes, the tabular grain aspect is generally up to 50:1. The grain size of ultrathin tabular grains may be determined by any of the methods commonly employed in the art for particle size measurement, such as those described above. Ultrathin tabular grains having these properties are described in U.S. Pat. No. 6,576,410 (Zou et al).

The ultrathin tabular silver halide grains can also be doped using one or more of the conventional metal dopants known for this purpose including those described in Research Disclosure, September 1996, item 38957 and U.S. Pat. No. 5,503,970 (Olm et al), incorporated herein by reference. Preferred dopants include iridium (III or IV) and ruthenium (II or III) salts.

It is also effective to use an in-situ process in which a halide-containing compound is added to an organic silver salt to partially convert the silver of the organic silver salt to silver halide. The halogen-containing compound can be inorganic (such as zinc bromide, calcium bromide, or lithium bromide) or organic (such as N-bromosuccinimide). Additional methods of preparing these silver halide and organic silver salts and manners of blending them are described in Research Disclosure, June 1978, item 17029, U.S. Pat. No. 3,700,458 (Lindholm), U.S. Pat. No. 4,076,539 (Ikenoue et al), JP Kokai 49-013224 A, (Fuji), JP Kokai 50-017216 A (Fuji), and JP Kokai 51-042529 A (Fuji). It is particularly effective to use a mixture of both in-situ and ex-situ silver halide grains.

In some instances, it may be helpful to prepare the LIFCS silver halide grains in the presence of a hydroxytetraazaindene (such as 4-hydroxy-6-methyl-1,3,3a,7-tetraazaindene) or an N-heterocyclic compound comprising at least one mercapto group (such as 1-phenyl-5-mercaptotetrazole) to provide increased photo speed. Details of this procedure are provided in U.S. Pat. No. 6,413,710 (Shor et al), that is incorporated herein by reference.

The one or more LIFCS sensitive silver halides used in the present invention are preferably present in an amount of from about 0.005 to about 0.5 mole, more preferably from about 0.01 to about 0.25 mole, and most preferably from about 0.03 to about 0.15 mole, per mole of non-LIFCS source of reducible silver ions.

The LIFCS sensitive silver halides used in thermally developable materials of the invention may be employed without modification. However, one or more conventional chemical sensitizers may be used in the preparation of the LIFCS sensitive silver halides to increase photo speed. Such compounds may contain sulfur, tellurium, or selenium, or may comprise a compound containing gold, platinum, palladium, ruthenium, rhodium, iridium, or combinations thereof, a reducing agent such as a tin halide or a combination of any of these. The details of these materials are provided for example, in T. H. James, The Theory of the Photographic Process, Fourth Edition, Eastman Kodak Company, Rochester, N.Y., 1977, Chapter 5, pp. 149-169. Suitable conventional chemical sensitization procedures are also described in U.S. Pat. No. 1,623,499 (Sheppard et al), U.S. Pat. No. 2,399,083 (Waller et al), U.S. Pat. No. 3,297,447 (McVeigh), U.S. Pat. No. 3,297,446 (Dunn), Deaton U.S. Pat. Nos. 5,049,485; 5,252,455; and 5,391,727; U.S. Pat. No. 5,912,111 (Lok et al), U.S. Pat. No. 5,759,761 (Lushington et al), U.S. Pat. No. 6,296,998 (Eikenberry et al), and EP 0 915 371 A1 (Lok et al).

In addition, mercaptotetrazoles and tetraazaindenes as described in U.S. Pat. No. 5,691,127 (Daubendiek et al), incorporated herein by reference, can be used as suitable addenda for tabular silver halide grains. When used, sulfinur sensitization is usually performed by adding a sulfur sensitizer and stirring the emulsion at an appropriate temperature for a predetermined time. Various sulfur compounds can be used. Some examples of sulfur sensitizers include thiosulfates, thioureas, thioamides, thiazoles, rhodanines, phosphine sulfides, thiohydantoins, 4-oxo-oxazolidine-2-thiones, dipolysulfides, mercapto compounds, polythionates, and elemental sulfur.

Certain tetrasubstituted thiourea compounds are also useful in the present invention. Such compounds are described, for example in U.S. Pat. No. 6,296,998 (Eikenberry et al), U.S. Pat. No. 6,322,961 (Lam et al) and U.S. Pat. No. 6,368,779 (Lynch et al). Also useful are the tetrasubstituted middle chalcogen (that is, sulfur, selenium, and tellurium) thiourea compounds disclosed in U.S. Pat. No. 4,810,626 (Burgmaier et a.). All of the above publications are incorporated herein by reference.

The amount of the sulfur sensitizer to be added varies depending upon various conditions such as pH, temperature and grain size of silver halide at the time of chemical ripening, it is preferably from 10⁻⁷ to 10⁻² mole per mole of silver halide, and more preferably from 10⁻⁶ to 10⁻⁴ mole per mole of silver halide. In one embodiment, chemical sensitization is achieved by oxidative decomposition of a sulfur-containing spectral sensitizing dye in the presence of a photothermographic emulsion. Such sensitization is described in U.S. Pat. No. 5,891,615 (Winslow et al), incorporated herein by reference.

Still other useful chemical sensitizers include certain selenium-containing compounds. When used, selenium sensitization is usually performed by adding a selenium sensitizer and stirring the emulsion at an appropriate temperature for a predetermined time. Some specific examples of useful selenium compounds can be found in Sasaki et al U.S. Pat. Nos. 5,158,892; and 5,238,807; 5,942,384 (Arai et al) and in copending and commonly assigned U.S. Ser. No. 10/082,516 (filed Feb. 25, 2002 by Lynch, Opatz, Gysling, and Simpson). All of the above documents are incorporated herein by reference.

Still other useful chemical sensitizers include certain tellurium-containing compounds. When used, tellurium sensitization is usually performed by adding a tellurium sensitizer and stirring the emulsion at an appropriate temperature for a predetermined time. Tellurium compounds for use as chemical sensitizers can be selected from those described in J. Chem. Soc., Chem. Commun. 1980, 635, ibid., 1979, 1102, ibid., 1979, 645, J. Chem. Soc. Perkin. Trans, 1980, 1, 2191, The Chemistry of Organic Selenium and Tellurium Compounds, S. Patai and Z. Rappoport, Eds., Vol. 1 (1986), and Vol. 2 (1987), U.S. Pat. No. 1,623,499 (Sheppard et al.), U.S. Pat. No. 3,320,069 (Illingsworth), U.S. Pat. No. 3,772,031 (Berry et al.), U.S. Pat. No. 5,215,880 (Kojima et al.), U.S. Pat. No. 5,273,874 (Kojima et al.), U.S. Pat. No. 5,342,750 (Sasaki et al.), U.S. Pat. No. 5,677,120 (Lushington et al.), British Patent 235,211 (Sheppard), British Patent 1,121,496 (Halwig), British Patent 1,295,462 (Hilson et al.) British Patent 1,396,696 (Simons), JP Kokai 04-271341 A (Morio et al.), in co-pending and commonly assigned U.S. Published Application No. 2002-0164549 (Lynch et al.), and in co-pending and commonly assigned U.S. Published Application No. 2003-0073026 (Gysling et al.). All of the above documents are incorporated herein by reference.

The amount of the selenium or tellurium sensitizer used in the present invention varies depending on silver halide grains used or chemical ripening conditions. However, it is generally from 10⁻⁸ to 10⁻² mole per mole of silver halide, preferably on the order of from 10⁻⁷ to 10⁻³ mole of silver halide.

Noble metal sensitizers for use in the present invention include gold, platinum, palladium and iridium. Gold sensitization is particularly preferred. When used, the gold sensitizer used for the gold sensitization of the silver halide emulsion used in the present invention may have an oxidation number of 1 or 3, and may be a gold compound commonly used as a gold sensitizer. U.S. Pat. No. 5,858,637 (Eshelman et al.) describes various Au (I) compounds that can be used as chemical sensitizers. Other useful gold compounds can be found in U.S. Pat. No. 5,759,761 (Lushington et al.). Useful combinations of gold (I) complexes and rapid sulfiding agents are described in U.S. Pat. No. 6,322,961 (Lam et al.). Combinations of gold (III) compounds and either sulfur- or tellurium-containing compounds are useful as chemical sensitizers and are described in U.S. Pat. No. 6,423,481 (Simpson et al.). All of the above references are incorporated herein by reference.

Reduction sensitization may also be used. Specific examples of compounds useful in reduction sensitization include, but are not limited to, stannous chloride, hydrazine ethanolamine, and thioureaoxide. Reduction sensitization may be performed by ripening the grains while keeping the emulsion at pH 7 or above, or at pAg 8.3 or less.

The chemical sensitizers can be used in making the silver halide emulsions in conventional amounts that generally depend upon the average size of the silver halide grains. Generally, the total amount is at least 10⁻¹⁰ mole per mole of total silver, and preferably from about 10⁻⁸ to about 10⁻² mole per mole of total silver. The upper limit can vary depending upon the compound(s) used, the level of silver halide, and the average grain size and grain morphology, and would be readily determinable by one of ordinary skill in the art.

The non-LIFCS sensitive source of reducible silver ions used in the materials of this invention can be any organic compound that contains reducible silver (1+) ions. Preferably, it is an organic silver salt that is comparatively stable to light and forms a silver image when heated to 50° C. or higher in the presence of an exposed catalyst (such as silver halide) and a reducing composition.

Silver salts of organic acids including silver salts of long-chain carboxylic acids are preferred. The chains typically contain 10 to 30, and preferably 15 to 28, carbon atoms. Suitable organic silver salts include silver salts of organic compounds having a carboxylic acid group. Examples thereof include a silver salt of an aliphatic carboxylic acid or a silver salt of an aromatic carboxylic acid. Preferred examples of the silver salts of aliphatic carboxylic acids include silver behenate, silver arachidate, silver stearate, silver oleate, silver laurate, silver caprate, silver myristate, silver palmitate, silver maleate, silver fumarate, silver tartarate, silver furoate, silver linoleate, silver butyrate, silver camphorate, and mixtures thereof. Preferably, at least silver behenate is used alone or in mixtures with other silver carboxylates.

Representative silver salts of aromatic carboxylic acid and other carboxylic acid group-containing compounds include, but are not limited to, silver benzoate, silver substituted-benzoates (such as silver 3,5-dihydroxy-benzoate, silver o-methylbenzoate, silver m-methylbenzoate, silver p-methylbenzoate, silver 2,4-dichlorobenzoate, silver acetamidobenzoate, silver p-phenylbenzoate), silver tannate, silver phthalate, silver terephthalate, silver salicylate, silver phenylacetate, and silver pyromellitate.

Silver salts of aliphatic carboxylic acids containing a thioether group as described in U.S. Pat. No. 3,330,663 (Weyde et al.) are also useful. Soluble silver carboxylates comprising hydrocarbon chains incorporating ether or thioether linkages, or sterically hindered substitution in the α-(on a hydrocarbon group) or ortho-(on an aromatic group) position, and displaying increased solubility in coating solvents and affording coatings with less light scattering can also be used. Such silver carboxylates are described in U.S. Pat. No. 5,491,059 (Whitcomb). Mixtures of any of the silver salts described herein can also be used if desired.

Silver salts of dicarboxylic acids are also useful. Such acids may be aliphatic, aromatic, or heterocyclic. Examples of such acids include, for example, phthalic acid, glutamic acid, or homo-phthalic acid. Silver salts of sulfonates are also useful in the practice of this invention. Such materials are described for example in U.S. Pat. No. 4,504,575 (Lee). Silver salts of sulfosuccinates are also useful as described for example in EP 0 227 141A1 (Leenders et al.).

Silver salts of compounds containing mercapto or thione groups and derivatives thereof can also be used. Preferred examples of these compounds include, but are not limited to, a heterocyclic nucleus containing 5 or 6 atoms in the ring, at least one of which is a nitrogen atom, and other atoms being carbon, oxygen, or sulfur atoms. Such heterocyclic nuclei include, but are not limited to, triazoles, oxazoles, thiazoles, thiazolines, imidazoles, diazoles, pyridines, and triazines. Representative examples of these silver salts include, but are not limited to, a silver salt of 3-mercapto-4-phenyl-1,2,4-triazole, a silver salt of 5-carboxylic-1-methyl-2-phenyl-4-thiopyridine, a silver salt of mercaptotriazine, a silver salt of 2-mercaptobenzoxazole, silver salts as described in U.S. Pat. No. 4,123,274 (Knight et al) (for example, a silver salt of a 1,2,4-mercaptothiazole derivative, such as a silver salt of 3-amino-5-benzylthio-1,2,4-thiazole), and a silver salt of thione compounds [such as a silver salt of 3-(2-carboxyethyl)-4-methyl-4-thiazoline-2-thione as described in U.S. Pat. No. 3,785,830 (Sullivan et al)].

Examples of other useful silver salts of mercapto or thione substituted compounds that do not contain a heterocyclic nucleus include, but are not limited to, a silver salt of thioglycolic acids such as a silver salt of an S-alkylthioglycolic acid (wherein the alkyl group has from 12 to 22 carbon atoms), a silver salt of a dithiocarboxylic acid such as a silver salt of a dithioacetic acid, and a silver salt of a thioamide. Moreover, silver salts of acetylenes can also be used as described, for example in U.S. Pat. No. 4,761,361 (Ozaki et al) and U.S. Pat. No. 4,775,613 (Hirai et al).

In some embodiments, a silver salt of a compound containing an imino group can be used, especially in aqueous-based imaging formulations. Preferred examples of these compounds include, but are not limited to, silver salts of benzotriazole and substituted derivatives thereof (for example, silver methylbenzotriazole and silver 5-chlorobenzotriazole), silver salts of 1,2,4-triazoles or 1-H-tetrazoles such as phenylmercaptotetrazole as described in U.S. Pat. No. 4,220,709 (deMauriac), and silver salts of imidazoles and imidazole derivatives as described in U.S. Pat. No. 4,260,677 (Winslow et al.). Particularly useful silver salts of this type are the silver salts of benzotriazole and substituted derivatives thereof. A silver salt of benzotriazole is preferred in aqueous-based photothermographic formulations.

Organic silver salts that are particularly useful in organic solvent-based materials include silver carboxylates (both aliphatic and aromatic carboxylates), silver triazolates, silver sulfonates, silver sulfosuccinates, and silver acetylides. Silver salts of long-chain aliphatic carboxylic acids containing 15 to 28, carbon atoms and silver salts are particularly preferred.

It is also convenient to use silver half soaps. A preferred example of a silver half soap is an equimolar blend of silver carboxylate and carboxylic acid, which analyzes for about 14.5% by weight solids of silver in the blend and which is prepared by precipitation from an aqueous solution of an ammonium or an alkali metal salt of a commercially available fatty carboxylic acid, or by addition of the free fatty acid to the silver soap. For transparent films a silver carboxylate full soap, containing not more than about 15% of free fatty carboxylic acid and analyzing for about 22% silver, can be used. For opaque materials, different amounts can be used. The methods used for making silver soap emulsions are well known in the art and are disclosed in Research Disclosure, April 1983, item 22812, Research Disclosure, October 1983, item 23419, U.S. Pat. No. 3,985,565 (Gabrielsen et al) and the references cited above.

Non-LIFCS sensitive sources of reducible silver ions can also be provided as core-shell silver salts such as those described in U.S. Pat. No. 6,355,408B1 (Whitcomb et al), that is incorporated herein by reference. These silver salts include a core comprised of one or more silver salts and a shell having one or more different silver salts.

Another useful source of non-LIFCS sensitive reducible silver ions in the practice of this invention are the silver dimer compounds that comprise two different silver salts as described in U.S. Pat. No. 6,472,131B1 (Whitcomb), that is incorporated herein by reference. Such non-LIFCS sensitive silver dimer compounds comprise two different silver salts, provided that when the two different silver salts comprise straight-chain, saturated hydrocarbon groups as the silver coordinating ligands, those ligands differ by at least 6 carbon atoms.

Still other useful sources of non-LIFCS sensitive reducible silver ions in the practice of this invention are the silver core-shell compounds comprising a primary core comprising one or more LIFCS sensitive silver halides, or one or more non-LIFCS sensitive inorganic metal salts or non-silver containing organic salts, and a shell at least partially covering the primary core, wherein the shell comprises one or more non-LIFCS sensitive silver salts, each of which silver salts comprises a organic silver coordinating ligand. Such compounds are described in copending and commonly assigned U.S. Ser. No. 10/208,603 (filed Jul. 30, 2002 by Bokhonov, Burleva, Whitcomb, Howlader, and Leichter) that is incorporated herein by reference.

As one skilled in the art would understand, the non-LIFCS sensitive source of reducible silver ions can include various mixtures of the various silver salt compounds described herein, in any desirable proportions.

The silver halide and the non-LIFCS sensitive source of reducible silver ions must be in catalytic proximity (that is, reactive association). It is preferred that these reactive components be present in the same emulsion layer.

The one or more non-LIFCS sensitive sources of reducible silver ions are preferably present in an amount of about 5% by weight to about 70% by weight, and more preferably, about 10% to about 50% by weight, based on the total dry weight of the emulsion layers. Stated another way, the amount of the sources of reducible silver ions is generally present in an amount of from about 0.001 to about 0.2 mol/m² of the dry material, and preferably from about 0.01 to about 0.05 mol/m² of that material.

The total amount of silver (from all silver sources) in the materials is generally at least 0.002 mol/m² and preferably from about 0.01 to about 0.05 mol/m.

The reducing agent (or reducing agent composition comprising two or more components) for the source of reducible silver ions can be any material, preferably an organic material, that can reduce silver (I) ion to metallic silver.

Conventional photographic developers can be used as reducing agents, including aromatic di- and tri-hydroxy compounds (such as hydroquinones, gallic acid and gallic acid derivatives, catechols, and pyrogallols), aminophenyls (for example, N-methylaminophenyl), sulfonamidophenyls, p-phenylenediamines, alkoxynaphthols (for example, 4-methoxy-1-naphthol), pyrazolidin-3-one type reducing agents (for example PHENIDONE), pyrazolin-5-ones, polyhydroxy spiro-bis-indanes, indan-1,3-dione derivatives, hydroxytetrone acids, hydroxytetronimides, hydroxylamine derivatives such as for example those described in U.S. Pat. No. 4,082,901 (Laridon et al.), hydrazine derivatives, hindered phenyls, amidoximes, azines, reductones (for example, ascorbic acid and ascorbic acid derivatives), leuco dyes, and other materials readily apparent to one skilled in the art.

When a silver salt of a compound containing an imino group (such as, for example, a silver benzotriazole) is used as the source of reducible silver ions, ascorbic acid reducing agents are preferred. An “ascorbic acid” reducing agent (also referred to as a developer or developing agent) means ascorbic acid, complexes thereof, and derivatives thereof. Ascorbic acid developing agents are described in a considerable number of publications in photographic processes, including U.S. Pat. No. 5,236,816 (Purol et al) and references cited therein.

Useful ascorbic acid developing agents include ascorbic acid and the analogues, isomers, complexes, and derivatives thereof. Such compounds include, but are not limited to, D- or L-ascorbic acid, 2,3-dihydroxy-2-cyclohexen-1-one, 3,4-dihydroxy-5-phenyl-2(5H)-furanone, sugar-type derivatives thereof (such as sorboascorbic acid, γ-lactoascorbic acid, 6-desoxy-L-ascorbic acid, L-rhamnoascorbic acid, imino-6-desoxy-L-ascorbic acid, glucoascorbic acid, fucoascorbic acid, glucoheptoascorbic acid, maltoascorbic acid, L-arabosascorbic acid), sodium ascorbate, niacinamide ascorbate, potassium ascorbate, isoascorbic acid (or L-erythroascorbic acid), and salts thereof (such as alkali metal, ammonium or others known in the art), endiol type ascorbic acid, an enaminol type ascorbic acid, a thioenol type ascorbic acid, and an enamin-thiol type ascorbic acid, as described for example in U.S. Pat. No. 5,498,511 (Yamashita et al.), EP 0 585 792 A1 (Passarella et al.), EP 0 573 700 A1 (Lingier et al.), EP 0 588 408 A1 (Hieronymus et al.), U.S. Pat. No. 5,089,819 (Knapp), U.S. Pat. No. 5,278,035 (Knapp), U.S. Pat. No. 5,384,232 (Bishop et al.), U.S. Pat. No. 5,376,510 (Parker et al.), Japanese Kokai 7-56286 (Toyoda), U.S. Pat. No. 2,688,549 (James et al.), and Research Disclosure, March 1995, Item 37152. D-, L-, or D,L-ascorbic acid (and alkali metal salts thereof) or isoascorbic acid (or alkali metal salts thereof) are preferred. Sodium ascorbate and sodium isoascorbate are most preferred. Mixtures of these developing agents can be used if desired.

When a silver carboxylate silver source is used, hindered phenyl reducing agents are preferred. In some instances, the reducing agent composition comprises two or more components such as a hindered phenyl developer and a co-developer that can be chosen from the various classes of co-developers and reducing agents described below. Ternary developer mixtures involving the further addition of contrast enhancing agents are also useful. Such contrast enhancing agents can be chosen from the various classes of reducing agents described below.

“Hindered phenyl reducing agents” are compounds that contain only one hydroxy group on a given phenyl ring and have at least one additional substituent located ortho to the hydroxy group. Hindered phenyl reducing agents may contain more than one hydroxy group as long as each hydroxy group is located on different phenyl rings. Hindered phenyl reducing agents include, for example, binaphthols (that is dihydroxybinaphthyls), biphenyls (that is dihydroxybiphenyls), bis(hydroxynaphthyl)methanes, bis(hydroxyphenyl)methanes (that is bisphenyls), hindered phenyls, and hindered naphthols, each of which may be variously substituted.

Representative binaphthols include, but are not limited, to 1,1′-bi-2-naphthol, 1,1′-bi-4-methyl-2-naphthol and 6,6′-dibromo-bi-2-naphthol. For additional compounds see U.S. Pat. No. 3,094,417 (Workman) and U.S. Pat. No. 5,262,295 (Tanaka et al.), both incorporated herein by reference. Representative biphenyls include, but are not limited, to 2,2′-dihydroxy-3,3′-di-t-butyl-5,5-dimethylbiphenyl, 2,2′-dihydroxy-3,3′,5,5′-tetra-t-butylbiphenyl, 2,2′-dihydroxy-3,3′-di-t-butyl-5,5′-dichlorobiphenyl, 2-(2-hydroxy-3-t-butyl-5-methylphenyl)-4-methyl-6-n-hexylphenyl, 4,4′-dihydroxy-3,3′,5,5′-tetra-t-butylbiphenyl and 4,4′-dihydroxy-3,3′,5,5′-tetramethylbiphenyl. For additional compounds see U.S. Pat. No. 5,262,295 (noted above). Representative bis(hydroxynaphthyl)methanes include, but are not limited to, 4,4′-methylenebis(2-methyl-1-naphthol). For additional compounds see U.S. Pat. No. 5,262,295 (noted above).

Representative bis(hydroxyphenyl)methanes include, but are not limited to, bis(2-hydroxy-3-t-butyl-5-methylphenyl)methane (CAO-5), 1,1′-bis(2-hydroxy-3,5-dimethylphenyl)-3,5,5-trimethylhexane (NONOX® or PERMANAX WSO), 1,1′-bis(3,5-di-t-butyl-4-hydroxyphenyl)methane, 2,2′-bis(4-hydroxy-3-methylphenyl)propane, 4,4′-ethylidene-bis(2-t-butyl-6-methylphenyl), 2,2′-isobutylidene-bis(4,6-dimethylphenyl) (LOWINOX® 221B46), and 2,2′-bis(3,5-dimethyl-4-hydroxyphenyl)propane. For additional compounds see U.S. Pat. No. 5,262,295 (noted above).

Representative hindered phenyls include, but are not limited to, 2,6-di-t-butylphenyl, 2,6-di-t-butyl-4-methylphenyl, 2,4-di-t-butylphenyl, 2,6-dichlorophenyl, 2,6-dimethylphenyl and 2-t-butyl-6-methylphenyl. Representative hindered naphthols include, but are not limited to, 1-naphthol, 4-methyl-1-naphthol, 4-methoxy-1-naphthol, 4-chloro-1-naphthol and 2-methyl-1-naphthol. For additional compounds see U.S. Pat. No. 5,262,295 (noted above). Mixtures of hindered phenyl reducing agents can be used if desired.

More specific alternative reducing agents that have been disclosed in dry silver systems including amidoximes such as phenylamidoxime, 2-thienyl-amidoxime and p-phenoxyphenylamidoxime, azines (for example, 4-hydroxy-3,5-dimethoxybenzaldehydrazine), a combination of aliphatic carboxylic acid aryl hydrazides and ascorbic acid [such as 2,2′-bis(hydroxymethyl)-propionyl-β-phenyl hydrazide in combination with ascorbic acid], a combination of polyhydroxybenzene and hydroxylamine, a reductone and/or a hydrazine [for example, a combination of hydroquinone and bis(ethoxyethyl)hydroxylamine], piperidinohexose reductone or formyl-4-methylphenylhydrazine, hydroxamic acids (such as phenylhydroxamic acid, p-hydroxyphenylhydroxamic acid, and o-alaninehydroxamic acid), a combination of azines and sulfonamidophenyls (for example, phenothiazine and 2,6-dichloro-4-benzenesulfonamidophenyl), α-cyanophenylacetic acid derivatives (such as ethyl α-cyano-2-methylphenylacetate and ethyl α-cyanophenylacetate), bis-o-naphthols [such as 2,2′-dihydroxy-1-binaphthyl, 6,6′-dibromo-2,2′-dihydroxy-1,1′-binaphthyl, and bis(2-hydroxy-1-naphthyl)methane], a combination of bis-o-naphthol and a 1,3-dihydroxybenzene derivative (for example, 2,4-dihydroxybenzophenone or 2,4-dihydroxyacetophenone), 5-pyrazolones such as 3-methyl-1-phenyl-5-pyrazolone, reductones (such as dimethylaminohexose reductone, anhydrodihydro-aminohexose reductone and anhydrodihydro-piperidone-hexose reductone), sulfonamidophenyl reducing agents (such as 2,6-dichloro-4-benzenesulfonamido-phenyl, and p-benzenesulfonamidophenyl), indane-1,3-diones (such as 2-phenylindane-1,3-dione), chromans (such as 2,2-dimethyl-7-t-butyl-6-hydroxychroman), 1,4-dihydropyridines (such as 2,6-dimethoxy-3,5-dicarbethoxy-1,4-dihydropyridine), ascorbic acid derivatives (such as 1-ascorbyl-palmitate, ascorbylstearate and unsaturated aldehydes and ketones), 3-pyrazolidones, and certain indane-1,3-diones.

An additional class of reducing agents that can be used as developers are substituted hydrazines including the sulfonyl hydrazides described in U.S. Pat. No. 5,464,738 (Lynch et al.). Still other useful reducing agents are described, for example, in U.S. Pat. No. 3,074,809 (Owen), U.S. Pat. No. 3,094,417 (Workman), U.S. Pat. No. 3,080,254 (Grant, Jr.), and U.S. Pat. No. 3,887,417 (Klein et al.). Auxiliary reducing agents may be useful as described in U.S. Pat. No. 5,981,151 (Leenders et al.). All of these patents are incorporated herein by reference.

Useful co-developer reducing agents can also be used as described for example, in U.S. Pat. No. 6,387,605 (Lynch et al.), that is incorporated herein by reference. Examples of these compounds include, but are not limited to, 2,5-dioxo-cyclopentane carboxaldehydes, 5-(hydroxymethylene)-2,2-dimethyl-1,3-dioxane-4,6-diones, 5-(hydroxymethylene)-1,3-dialkylbarbituric acids, and 2-(ethoxymethylene)-1H-indene-1,3 (2H)-diones.

Additional classes of reducing agents that can be used as co-developers are trityl hydrazides and formyl phenyl hydrazides as described in U.S. Pat. No. 5,496,695 (Simpson et al.), 2-substituted malondialdehyde compounds as described in U.S. Pat. No. 5,654,130 (Murray), and 4-substituted isoxazole compounds as described in U.S. Pat. No. 5,705,324 (Murray). Additional developers are described in U.S. Pat. No. 6,100,022 (Inoue et al.). All of the patents above are incorporated herein by reference.

Yet another class of co-developers includes substituted acrylonitrile compounds that are described in U.S. Pat. No. 5,635,339 (Murray) and U.S. Pat. No. 5,545,515 (Murray et al.), both incorporated herein by reference. Examples of such compounds include, but are not limited to, the compounds identified as HET-01 and HET-02 in U.S. Pat. No. 5,635,339 (noted above) and CN-01 through CN-13 in U.S. Pat. No. 5,545,515 (noted above). Particularly useful compounds of this type are (hydroxymethylene)cyanoacetates and their metal salts.

Various contrast enhancing agents can be used in some thermally developed materials with specific co-developers. Examples of useful contrast enhancing agents include, but are not limited to, hydroxylamines (including hydroxylamine and alkyl- and aryl-substituted derivatives thereof), alkanolamines and ammonium phthalamate compounds as described for example, in U.S. Pat. No. 5,545,505 (Simpson), hydroxamic acid compounds as described for example, in U.S. Pat. No. 5,545,507 (Simpson et al.), N-acylhydrazine compounds as described for example, in U.S. Pat. No. 5,558,983 (Simpson et al.), and hydrogen atom donor compounds as described in U.S. Pat. No. 5,637,449 (Harring et al.). All of the patents above are incorporated herein by reference.

The reducing agent (or mixture thereof) described herein is generally present as 1 to 10% (dry weight) of the emulsion layer. In multilayer constructions, if the reducing agent is added to a layer other than an emulsion layer, slightly higher proportions, of from about 2 to 15 weight % may be more desirable. Any co-developers may be present generally in an amount of from about 0.001% to about 1.5% (dry weight) of the emulsion layer coating.

The use of “toners” or derivatives thereof that improve the image are highly desirable components of the thermally developed materials of this invention. Toners are compounds that improve image color by contributing to formation of a black image upon development. They may also facilitate an increase the optical density of the developed image. Without them, images are often faint and yellow or brown. Generally, one or more toners described herein are present in an amount of about 0.01% by weight to about 10%, and more preferably about 0.1% by weight to about 10% by weight, based on the total dry weight of the layer in which it is included. The amount can also be defined as being within the range of from about 1×10⁻⁵ to about 1.0 mol per mole of non-LIFCS sensitive source of reducible silver in the material. Toners may be incorporated in one or more of the thermally developable imaging layers as well as in adjacent layers such as a protective overcoat or underlying “carrier” layer.

Such compounds are well known materials in the photothermo-graphic art, as shown in U.S. Pat. No. 3,080,254 (Grant, Jr.), U.S. Pat. No. 3,847,612 (Winslow), U.S. Pat. No. 4,123,282 (Winslow), U.S. Pat. No. 4,082,901 (Laridon et al.), U.S. Pat. No. 3,074,809 (Owen), U.S. Pat. No. 3,446,648 (Workman), U.S. Pat. No. 3,844,797 (Willems et al.), U.S. Pat. No. 3,951,660 (Hagemann et al.), U.S. Pat. No. 5,599,647 (Defieuw et al.), and GB 1,439,478 (AGFA).

Examples of toners include, but are not limited to, phthalimide and N-hydroxyphthalimide, cyclic imides (such as succinimide), pyrazoline-5-ones, quinazolinone, 1-phenylurazole, 3-phenyl-2-pyrazoline-5-one, and 2,4-thiazolidinedione, naphthalimides (such as N-hydroxy-1,8-naphthalimide), cobalt complexes [such as hexaaminecobalt(3+) trifluoroacetate], mercaptans (such as 3-mercapto-1,2,4-triazole, 2,4-dimercaptopyrimidine, 3-mercapto-4,5-diphenyl-1,2,4-triazole and 2,5-dimercapto-1,3,4-thiadiazole), N-(amino-methyl)aryldicarboximides (such as (N,N-dimethylaminomethyl)phthalimide), and N-(dimethylaminomethyl)naphthalene-2,3-dicarboximide, a combination of blocked pyrazoles, isothiuronium derivatives, and certain photo bleach agents [such as a combination of N,N′-hexamethylene-bis(1-carbamoyl-3,5-dimethyl-pyrazole), 1,8-(3,6-diazaoctane)bis(isothiuronium)trifluoroacetate, and 2-(tribromomethylsulfonyl benzothiazole)], merocyanine dyes {such as 3-ethyl-5-[(3-ethyl-2-benzothiazolinylidene)-1-methyl-ethylidene]-2-thio-2,4-o-azolidine-dione}, phthalazine and derivatives thereof [such as those described in U.S. Pat. No. 6,146,822 (Asanuma et al.)], phthalazinone and phthalazinone derivatives, or metal salts or these derivatives [such as 4-(1-naphthyl)phthalazinone, 6-chlorophthalazinone, 5,7-dimethoxyphthalazinone, and 2,3-dihydro-1,4-phthalazinedione], a combination of phthalazine (or derivative thereof) plus one or more phthalic acid derivatives (such as phthalic acid, 4-methylphthalic acid, 4-nitrophthalic acid, and tetrachlorophthalic anhydride), quinazolinediones, benzoxazine or naphthoxazine derivatives, rhodium complexes functioning not only as tone modifiers but also as sources of halide ion for silver halide formation in-situ [such as ammonium hexachlororhodate (3+), rhodium bromide, rhodium nitrate, and potassium hexachlororhodate (3+)], benzoxazine-2,4-diones (such as 1,3-benzoxazine-2,4-dione, 8-methyl-1,3-benzoxazine-2,4-dione and 6-nitro-1,3-benzoxazine-2,4-dione), pyrimidines and asym-triazines (such as 2,4-dihydroxypyrimidine, 2-hydroxy-4-aminopyrimidine and azauracil) and tetraazapentalene derivatives [such as 3,6-dimercapto-1,4-diphenyl-1H, 4H-2,3 a,5,6a-tetraazapentalene and 1,4-di-(o-chlorophenyl)-3,6-dimercapto-1, 4H-2,3a,5,6a-tetraazapentalene].

Phthalazine and phthalazine derivatives [such as those described in U.S. Pat. No. 6,146,822 (noted above), incorporated herein by reference], phthalazinone, and phthalazinone derivatives are particularly useful toners.

Additional useful toners are substituted and unsubstituted mercaptotriazoles as described for example in U.S. Pat. No. 3,832,186 (Masuda et al.), U.S. Pat. No. 6,165,704 (Miyake et al.), U.S. Pat. No. 5,149,620 (Simpson et al.), and in copending and commonly assigned U.S. Ser. No. 10/193,443 (filed Jul. 11, 2002 by Lynch, Zou, and Ulrich), U.S. Ser. No. 10/192,944 (filed Jul. 11, 2002 by Lynch, Ulrich, and Zou), and U.S. Ser. No. 10/341,754 (filed Jan. 14, 2003 by Lynch, Ulrich, and Skoug). All of the above documents are incorporated herein by reference.

Also useful are the triazine thione compounds described in U.S. Ser. No. 10/341,754 (filed Jan. 14, 2003 by Lynch, Ulrich, and Skoug), and the heterocyclic disulfide compounds described in U.S. Ser. No. 10/384,244 (filed Mar. 7, 2003 by Lynch and Ulrich), both of which are incorporated herein by reference. Other useful toners are the phthalazine compounds described in U.S. Pat. No. 6,605,418 (Ramsden et al.), incorporated herein by reference.

The thermally developed materials of the invention can also contain other additives such as shelf-life stabilizers, antifoggants, contrast enhancing agents, development accelerators, acutance dyes, post-processing stabilizers or stabilizer precursors, thermal solvents (also known as melt formers), humectants, and other image-modifying agents as would be readily apparent to one skilled in the art. To further control the properties of the materials, (for example, contrast, Dmin, speed, or fog), it may be preferable to add one or more heteroaromatic mercapto compounds or heteroaromatic disulfide compounds of the formulae Ar—S—M¹ and Ar—S—S—Ar, wherein M¹ represents a hydrogen atom or an alkali metal atom and Ar represents a heteroaromatic ring or fused hetero-aromatic ring containing one or more of nitrogen, sulfur, oxygen, selenium, or tellurium atoms. Preferably, the heteroaromatic ring comprises benzimidazole, naphthimidazole, benzothiazole, naphthothiazole, benzoxazole, naphthoxazole, benzoselenazole, benzotellurazole, imidazole, oxazole, pyrazole, triazole, thiazole, thiadiazole, tetrazole, triazine, pyrimidine, pyridazine, pyrazine, pyridine, purine, quinoline, or quinazolinone. Compounds having other heteroaromatic rings and compounds providing enhanced sensitization at other wavelengths are also envisioned to be suitable. For example, heteroaromatic mercapto compounds are described as supersensitizers for infrared photothermographic materials in EP 0 559 228 B1 (Philip Jr. et al).

The thermally developed embodiment of the present invention can be further protected against the production of fog and can be stabilized against loss of sensitivity during storage. Suitable antifoggants and stabilizers that may be used alone or in combination include thiazolium salts as described in U.S. Pat. No. 2,131,038 (Staud) and U.S. Pat. No. 2,694,716 (Allen), azaindenes as described in U.S. Pat. No. 2,886,437 (Piper), triazaindolizines as described in U.S. Pat. No. 2,444,605 (Heimbach), the urazoles described in U.S. Pat. No. 3,287,135 (Anderson), sulfocatechols as described in U.S. Pat. No. 3,235,652 (Kennard), the oximes described in GB 623,448 (Carrol et al.), polyvalent metal salts as described in U.S. Pat. No. 2,839,405 (Jones), thiuronium salts as described in U.S. Pat. No. 3,220,839 (Herz), palladium, platinum, and gold salts as described in U.S. Pat. No. 2,566,263 (Trirelli) and U.S. Pat. No. 2,597,915 (Damshroder), compounds having —SO₂CBr₃ groups as described for example in U.S. Pat. No. 5,594,143 (Kirk et al.) and U.S. Pat. No. 5,374,514 (Kirk et al.), and 2-(tribromomethylsulfonyl)-quinoline compounds as described in U.S. Pat. No. 5,460,938 (Kirk et al.).

Stabilizer precursor compounds capable of releasing stabilizers upon application of heat during development can also be used. Such precursor compounds are described in for example, U.S. Pat. No. 5,158,866 (Simpson et al.), U.S. Pat. No. 5,175,081 (Krepski et al.), U.S. Pat. No. 5,298,390 (Sakizadeh et al.), and U.S. Pat. No. 5,300,420 (Kenney et al.).

In addition, certain substituted-sulfonyl derivatives of benzo-triazoles (for example alkylsulfonylbenzotriazoles and arylsulfonylbenzotriazoles) have been found to be useful stabilizing compounds (such as for post-processing print stabilizing), as described in U.S. Pat. No. 6,171,767 (Kong et al.). Furthermore, other specific useful antifoggants/stabilizers are described in more detail in U.S. Pat. No. 6,083,681 (Lynch et al.), incorporated herein by reference.

The materials may also include one or more polyhalo antifoggants that include one or more polyhalo substituents including but not limited to, dichloro, dibromo, trichloro, and tribromo groups. The antifoggants can be aliphatic, alicyclic or aromatic compounds, including aromatic heterocyclic and carbocyclic compounds. Particularly useful antifoggants of this type are polyhalo antifoggants, such as those having a —SO₂C(X′)₃ group wherein X′ represents the same or different halogen atoms. Another class of useful antifoggants includes those compounds described in U.S. Pat. No. 6,514,678 (Burgmaier et al.), incorporated herein by reference.

The thermally developed embodiment of this invention may also include one or more thermal solvents (also called “heat solvents,” “thermo-solvents,” “melt formers,” “melt modifiers,” “eutectic formers,” “development modifiers,” “waxes,” or “plasticizers”) for improving the reaction speed of the silver-developing redox reaction at elevated temperature. The term “thermal solvent” in this invention is meant an organic material that becomes a plasticizer or liquid solvent for at least one of the imaging layers upon heating at a temperature above 60° C. Useful for that purpose are polyethylene glycols having a mean molecular weight in the range of 1,500 to 20,000 described in U.S. Pat. No. 3,347,675 (Henn et al.). Also useful are compounds such as urea, methyl sulfonamide, and ethylene carbonate as described in U.S. Pat. No. 3,667,959 (Bojara et al.), and compounds such as tetrahydrothiophene-1,1-dioxide, methyl anisate, and 1,10-decanediol as described in Research Disclosure, December 1976, item 15027, pp. 26-28. Other representative examples of such compounds include, but are not limited to, niacinamide, hydantoin, 5,5-dimethylhydantoin, salicylanilide, phthalimide, N-hydroxyphthalimide, N-potassium-phthalimide, succinimide, N-hydroxy-1,8-naphthalimide, phthalazine, 1-(2H)-phthalazinone, 2-acetylphthalazinone, benzanilide, 1,3-dimethylurea, 1,3-diethylurea, 1,3-diallylurea, meso-erythritol, D-sorbitol, tetrahydro-2-pyrimidone, glycouril, 2-imidazolidone, 2-imidazolidone-4-carboxylic acid, and benzenesulfonamide. Combinations of these compounds can also be used including, for example, a combination of succinimide and 1,3-dimethylurea. Known thermal solvents are disclosed, for example, in U.S. Pat. No. 6,013,420 (Windender), U.S. Pat. No. 3,438,776 (Yudelson), U.S. Pat. No. 5,368,979 (Freedman et al.), U.S. Pat. No. 5,716,772 (Taguchi et al.), U.S. Pat. No. 5,250,386 (Aono et al.), and in Research Disclosure, December 1976, item 15022.

The LIFCS sensitive silver halide, the non-LIFCS sensitive source of reducible silver ions, the reducing agent composition, toner(s), and any other additives used in the present invention are added to and coated in one or more binders using a suitable solvent. For example, organic solvent-based or aqueous-based formulations can be used to prepare the materials of this invention. Mixtures of different types of hydrophilic and/or hydrophobic binders can also be used in these formulations.

Examples of useful hydrophilic binders include, but are not limited to, proteins and protein derivatives, gelatin and gelatin derivatives (hardened or unhardened, including alkali- and acid-treated gelatins, and deionized gelatin), cellulosic materials such as hydroxymethyl cellulose and cellulosic esters, acrylamide/methacrylamide polymers, acrylic/methacrylic polymers, polyvinyl pyrrolidones, polyvinyl alcohols, poly(vinyl lactams), polymers of sulfoalkyl acrylate or methacrylates, hydrolyzed polyvinyl acetates, polyamides, polysaccharides (such as dextrans and starch ethers), and other naturally occurring or synthetic vehicles commonly known for use in aqueous-based photographic emulsions (see for example Research Disclosure, September 1996, item 38957, noted above). Cationic starches can also be used as peptizers for emulsions containing tabular grain silver halides as described in U.S. Pat. No. 5,620,840 (Maskasky) and U.S. Pat. No. 5,667,955 (Maskasky). Particularly useful hydrophilic binders are gelatin, gelatin derivatives, polyvinyl alcohols, and cellulosic materials. Gelatin and its derivatives are most preferred, and comprise at least 75 weight % of total binders when a mixture of binders is used. Aqueous dispersions of water-dispersible polymer latexes may also be used, alone or with hydrophilic or hydrophobic binders described herein. Such dispersions are described in, for example, U.S. Pat. No. 4,504,575 (Lee), U.S. Pat. No. 6,083,680 (Ito et al), U.S. Pat. No. 6,100,022 (Inoue et al.), U.S. Pat. No. 6,132,949 (Fujita et al.), U.S. Pat. No. 6,132,950 (Ishigaki et al.), U.S. Pat. No. 6,140,038 (Ishizuka et al.), U.S. Pat. No. 6,150,084 (Ito et al.), U.S. Pat. No. 6,312,885 (Fujita et al.), U.S. Pat. No. 6,423,487 (Naoi), all of which are incorporated herein by reference.

Hardeners for various binders may be present if desired. Useful hardeners are well known and include diisocyanate compounds as described for example, in EP 0 600 586 B1 (Philip, Jr. et al.) and vinyl sulfone compounds as described in U.S. Pat. No. 6,143,487 (Philip, Jr. et al.), and EP 0 640 589 A1 (Gathmann et al.), aldehydes and various other hardeners as described in U.S. Pat. No. 6,190,822 (Dickerson et al.). The hydrophilic binders used in the materials are generally partially or fully hardened using any conventional hardener. Useful hardeners are well known and are described, for example, in T. H. James, The Theory of the Photographic Process, Fourth Edition, Eastman Kodak Company, Rochester, N.Y., 1977, Chapter 2, pp. 77-78. In some embodiments, the components needed for imaging can be added to one or more binders that are predominantly (at least 50% by weight of total binders) hydrophobic in nature. Thus, organic solvent-based formulations can be used to prepare the materials of this invention. Mixtures of hydrophobic binders can also be used. It is preferred that at least 80% (by weight) of the binders be hydrophobic polymeric materials such as, for example, natural and synthetic resins that are sufficiently polar to hold the other ingredients in solution or suspension.

Examples of typical hydrophobic binders include, but are not limited to, polyvinyl acetals, polyvinyl chloride, polyvinyl acetate, cellulose acetate, cellulose acetate butyrate, polyolefins, polyesters, polystyrenes, polyacrylonitrile, polycarbonates, methacrylate copolymers, maleic anhydride ester copolymers, butadiene-styrene copolymers, and other materials readily apparent to one skilled in the art. Copolymers (including terpolymers) are also included in the definition of polymers. The polyvinyl acetals (such as polyvinyl butyral and polyvinyl formal), cellulose ester polymers, and vinyl copolymers (such as polyvinyl acetate and polyvinyl chloride) are preferred. Particularly suitable binders are polyvinyl butyral resins that are available as BUTVAR® B79 (Solutia, Inc.) and PIOLOFORM® BS-18, PIOLOFORM® BN-18, PIOLOFORM® BM-18, or PIOLOFORM® BL-16 (Wacker Chemical Company) and cellulose ester polymers.

Where the proportions and activities of the thermally developed materials require a particular developing time and temperature, the binder(s) should be able to withstand those conditions. Generally, it is preferred that the binder does not decompose or lose its structural integrity at 120° C. for 60 seconds. It is more preferred that it does not decompose or lose its structural integrity at 177° C. for 60 seconds.

The polymer binder(s) is used in an amount sufficient to carry the components dispersed therein. The effective range of binder amount can be appropriately determined by one skilled in the art. Preferably, a binder is used at a level of about 10% by weight to about 90% by weight, and more preferably at a level of about 20% by weight to about 70% by weight, based on the total dry weight of the layer in which it is included.

The formulation for the thermally developed embodiment emulsion layer(s) can be prepared by dissolving and dispersing the binder, the catalyst, the non-LIFCS sensitive source of reducible silver ions, the reducing composition, and optional addenda in an organic solvent, such as toluene, 2-butanone (methyl ethyl ketone), acetone, or tetrahydrofuran.

Alternatively, these components can be formulated with a hydrophilic or water-dispersible polymer latex binder in water or water-organic solvent mixtures to provide aqueous-based coating formulations.

Layers to promote adhesion of one layer to another are also known, as described for example in U.S. Pat. No. 5,891,610 (Bauer et al.), U.S. Pat. No. 5,804,365 (Bauer et al.), and U.S. Pat. No. 4,741,992 (Przezdziecki). Adhesion can also be promoted using specific polymeric adhesive materials as described for example in U.S. Pat. No. 5,928,857 (Geisler et al).

Heat-bleachable compositions can be used in subbing layers or backside layers as antihalation compositions. Under practical conditions of use, such compositions are heated to provide bleaching at a temperature of at least 90° C. for at least 0.5 seconds. Preferably, bleaching is carried out at a temperature of from about 100° C. to about 200° C. for from about 5 to about 20 seconds. Most preferred bleaching is carried out within 20 seconds at a temperature of from about 110° C. to about 130° C.

It is also useful in the present invention to employ compositions including acutance or antihalation dyes that will decolorize or bleach with heat during processing. Dyes and constructions employing these types of dyes are described in, for example, U.S. Pat. No. 5,135,842 (Kitchin et al.), U.S. Pat. No. 5,266,452 (Kitchin et al.), U.S. Pat. No. 5,314,795 (Helland et al.), U.S. Pat. No. 6,306,566, (Sakurada et al.), U.S. Published Application 2001-0001704 (Sakurada et al.), JP Kokai 2001-142175 (Hanyu et al.), and JP 2001-183770 (Hanye et al.). Also useful are bleaching compositions described in JP Kokai 11-302550 (Fujiwara), JP Kokai 2001-109101 (Adachi), JP Kokai 2001-51371 (Yabuki et al.), JP Kokai 2001-22027 (Adachi), JP Kokai 2000-029168 (Noro), and U.S. Pat. No. 6,376,163 (Goswami, et al.). All of the above references are incorporated herein by reference.

Particularly, useful heat-bleachable antihalation compositions can include an infrared radiation absorbing compound such as an oxonol dyes and various other compounds used in combination with a hexaarylbiimidazole (also known as a “HABI”), or mixtures thereof. Such HABI compounds are well known in the art, such as U.S. Pat. No. 4,196,002 (Levinson et al.), U.S. Pat. No. 5,652,091 (Perry et al.), and U.S. Pat. No. 5,672,562 (Perry et al.), all incorporated herein by reference. Examples of such heat-bleachable compositions are described for example in U.S. Pat. Nos. 6,558,880 (Goswami et al.) and 6,514,677 (Ramsden et al.), both incorporated herein by reference.

Thermal development conditions will vary, depending on the construction used but will typically involve heating the LIFCS exposed material at a suitably elevated temperature. Thus, the latent image can be developed by heating the exposed material at a moderately elevated temperature of, for example, from about 50° C. to about 250° C. (preferably from about 80° C. to about 200° C. and more preferably from about 100° C. to about 200° C.) for a sufficient period of time, generally from about 1 to about 120 seconds. Heating can be accomplished using any suitable heating means such as a resistive heater, hot plate, a steam iron, a hot roller, mechanical finger or a heating bath. A preferred heat development procedure includes heating at from about 110° C. to about 135° C. for from about 3 to about 25 seconds. One can also use a light source, such as a laser beam, that is absorbed by any portion of the layered structure, but preferably the layer containing the latent image to develop, and preferably a wavelength that can be matched to absorb best in this layer without unwanted development, such as a near-infrared or infrared wavelength supplied by a near-infrared or infrared laser diode.

In some methods, the development is carried out in two steps. Thermal development takes place at a higher temperature for a shorter time (for example at about 150° C. for up to 10 seconds), followed by thermal diffusion at a lower temperature (for example at about 80° C.) in the presence of a transfer solvent.

In another two-step development method, thermal development can take place using a preheating step (for example at about 110° C. for up to 10 seconds), immediately followed by a final development step (for example at about 125° C. for up to 20 seconds).

After the sensor has been processed using any of the methods described above or using a conventional photographic processor, the sensor may be electronically scanned. The scan may then be digitized and analyzed using a computer (not shown) and the results of the computer analysis outputted via a printer or displayed electronically. The results of several individual sensors may be compared.

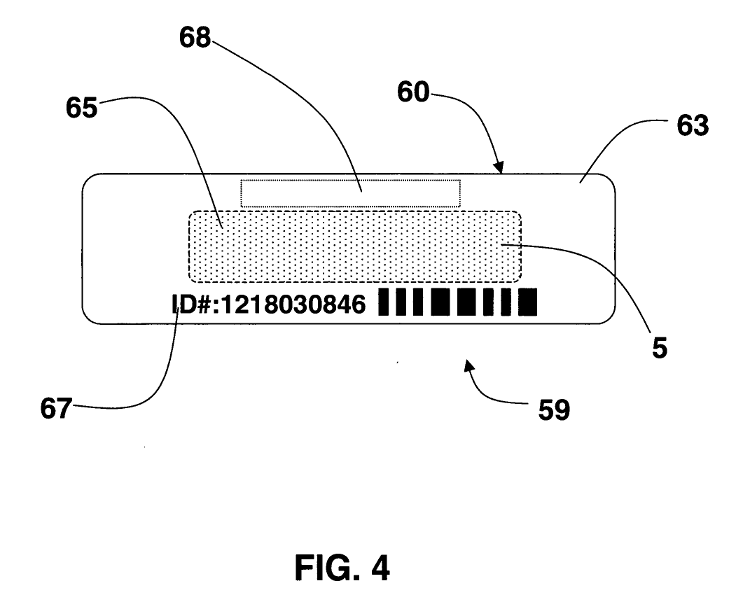

As noted above it is contemplated that the sensor may be used in the form of a test strip. A test kit 59 may include a test strip 60 and a method for developing said test strip. The test strip comprises a support 10 containing a non-sampling area 63, and a sampling area 65 which is comprised of the multilayer sensor 5 illustrated in FIG. 4. The non-sampling area is used, for example, to provide ease of handling, space for printed data 67, both eye readable and machine readable, such as an identification number, and a writeable area 68. The non-sampling area may surround the sampling area or the sampling area may be in a discrete portion of the test strip such as along the edge portion so that the strip may be held by the non-sampling area and dipped into a test sample. The optionally removable protective layer 35 covers at least the sampling area and protects the sampling area 65 (shown as a hidden view) until the test strip 60 is to be used. The protective layer may be light-blocking as described above for the light-blocking layer. The test strip may also comprise a release layer 45.

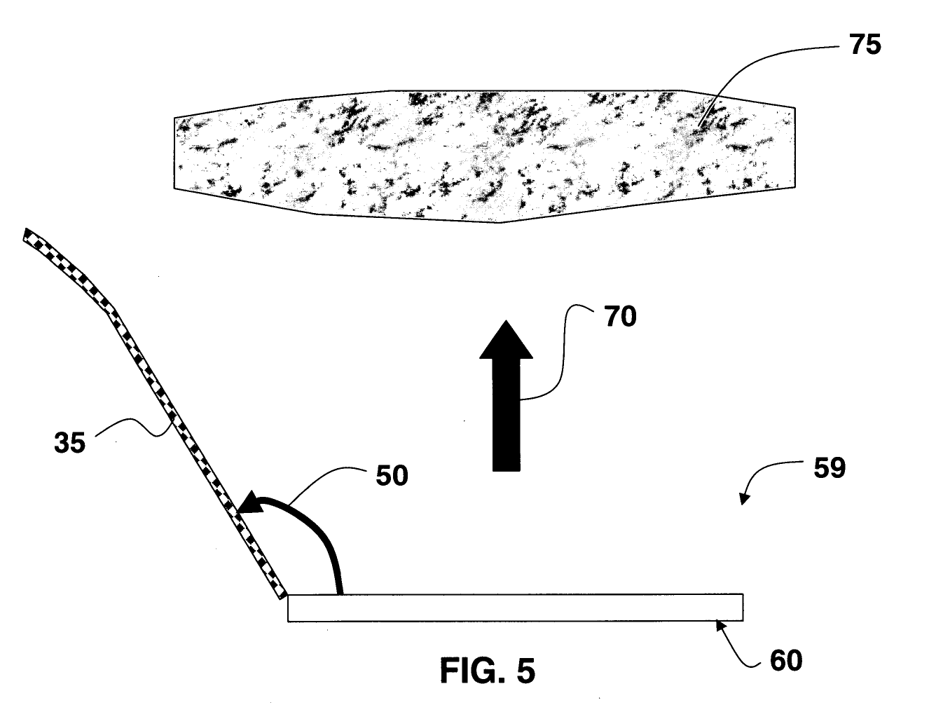

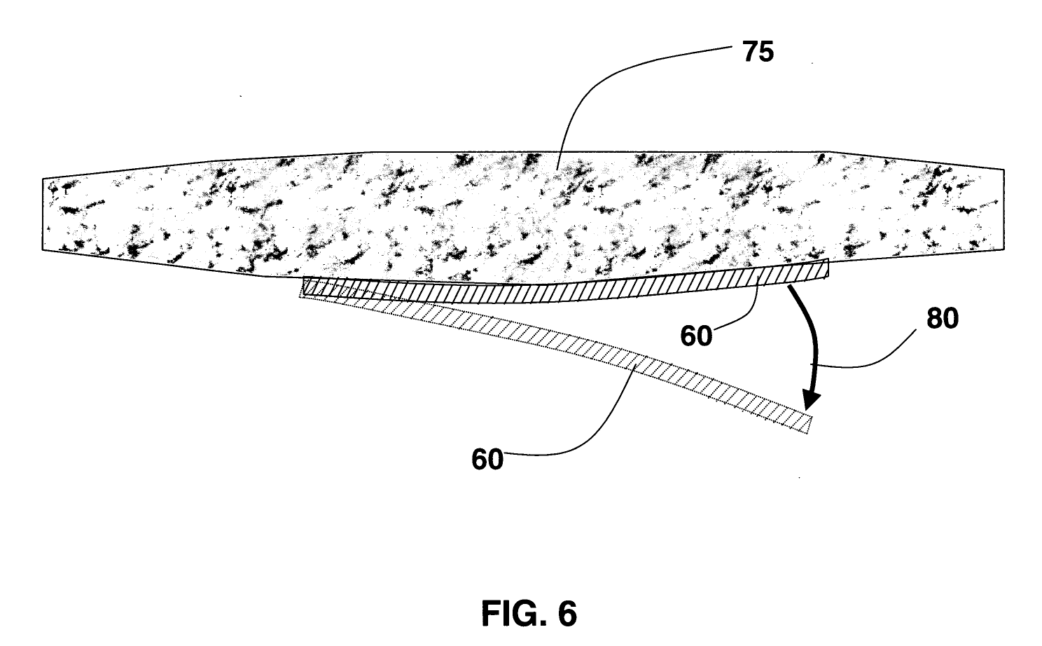

Referring now to FIG. 5, the optionally removable protective layer 35 is peeled off the test strip 60 as indicated by arrow 50 exposing the top surface of the sampling area 65 (i.e. the sampling layer 20 of the sensor 5). In the embodiment illustrated in FIGS. 5 and 6 the test strip 60 is firmly placed as indicated by arrow 70 against the test object 75, for example a piece of meet or an animal carcass. The test strip 60 is then peeled from the test object 75 as indicated by arrow 80 in FIG. 6. The test strip is then developed as described below. In this embodiment the removable protective layer 35 may be replaced after the developer is applied or prior to heat processing, allowing the results of the test to be viewed while keeping the sampling area 65 from being contaminated. It also prevents the user from touching the sampling area 65 and being exposed to the pathogen. The removable protective layer may include a fixing or stopping agent to stop development and/or fix the image.

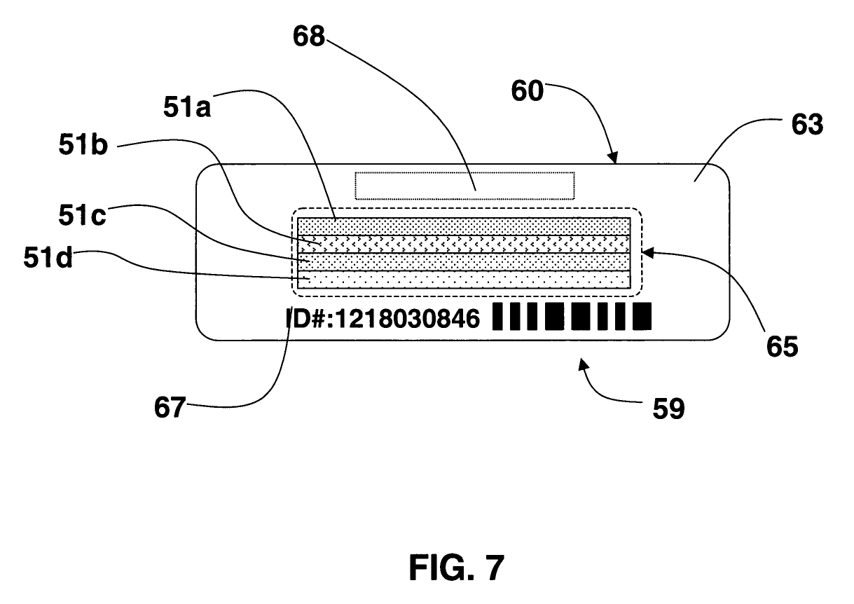

In yet another embodiment, as illustrated in FIG. 7, the sensor 5 can detect more than one type of contaminant. The sampling layer 20 of the sampling area 65 may be designed with multiple coatings, so that areas 51a, b, c and d of the strip are selective to different suspect pathogens.

In general, the test strip is contacted with the material to be tested and the silver halide image is allowed to form a latent image. The latent image is then developed to form a detectable signal. The signal may be an on/off signal or it may be measurable to indicate the amount of the target species present. The latent image may be developed by heat or by chemical processing. The signal is then read visually or by a densitometer. The test strip may be placed in contact with a test object or the test object may be contacted with a transfer device and the transfer device containing the test material placed in contact with the test strip.

A kit comprising a developing device and/or a transfer device and the test strip described above may be utilized. The transfer device may be, for example, a swab or a device for transferring liquid such as an eye dropper, a pipette or any other suitable device for transferring a test sample to the test strip. As noted, the developing device may be a simple heat developing apparatus as described below. The developing device might also be an applicator for chemical developer. The kit may comprise multiple test strips. It might also comprise a marking device for recording data, such as a marking pen or punch device.

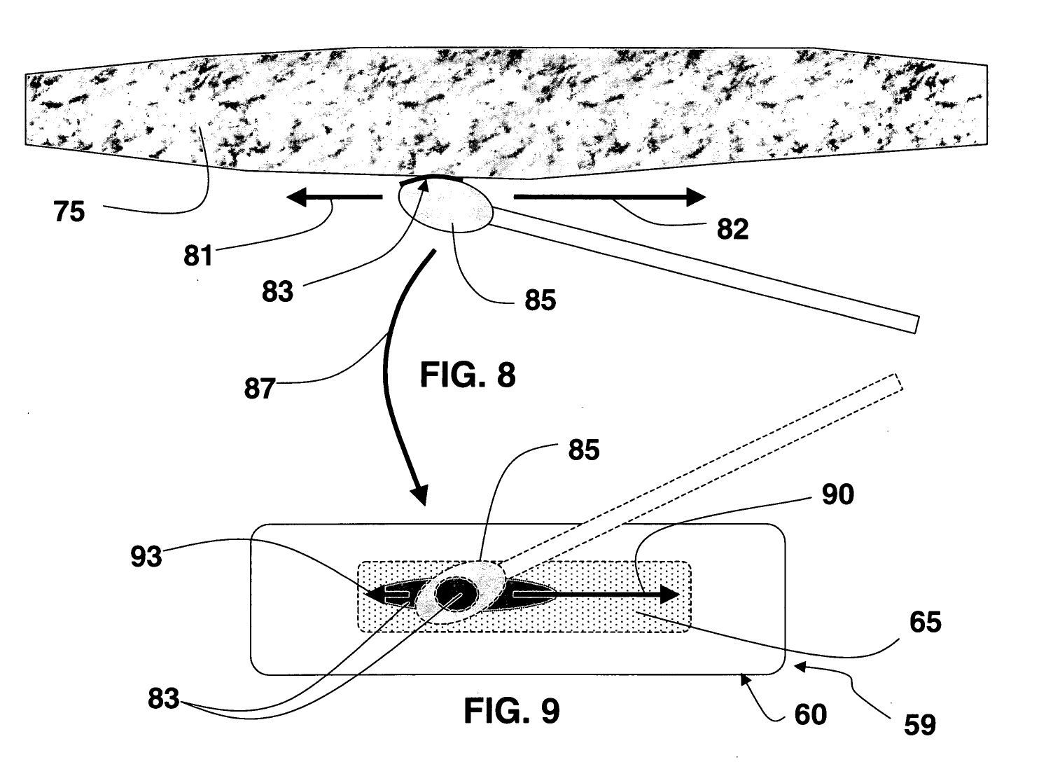

In the case of the agricultural sensor, as shown in FIGS. 8 and 9, the test object 75, for example food, is swabbed as indicated by arrows 81 and 82 respectively for suspected contamination. The sample 83 present on the swab 85 is applied to the sampling area 65 of the test strip 60 as indicated by arrow 87 in the direction indicated by arrows 90 and 93 respectively. At very low concentrations, the sampling layer would release chemistry (e.g., free radicals) that would diffuse to the silver halide layer, causing a latent image. This latent image is amplified when the sensor is either developed by a triggerable chemistry, or with heat. The development of the silver may result in a black and white image or in chemistry which develops uncolored compounds (known as couplers) to colored dyes. The black and white image or colors are observed, and recorded. They can be “stopped” or “fixed” at any point, can be scanned for density to obtain a quantitative number, and can be stored or catalogued for later use (confirmation, verification, audit, etc).

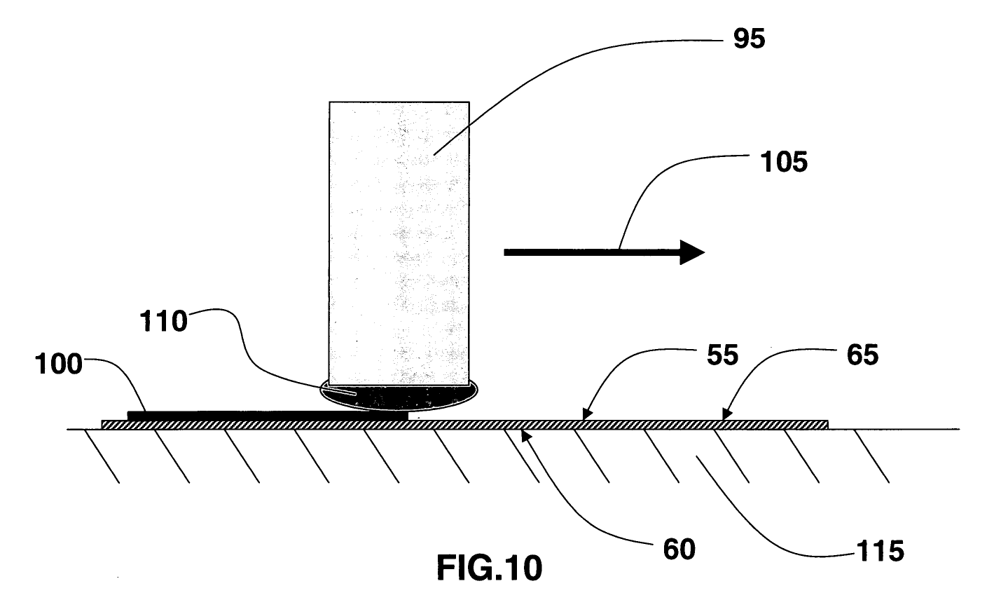

Black and white processing methods are well known in the art. As illustrated in FIG. 10, an applicator 95 containing a black and white developer 100 such as described above is applied to the top surface 55 of the test strip 60 (sampling area 65) in the direction indicated by arrow 105 by a pad 110 while the test strip 60 is securely resting on a flat surface 115.

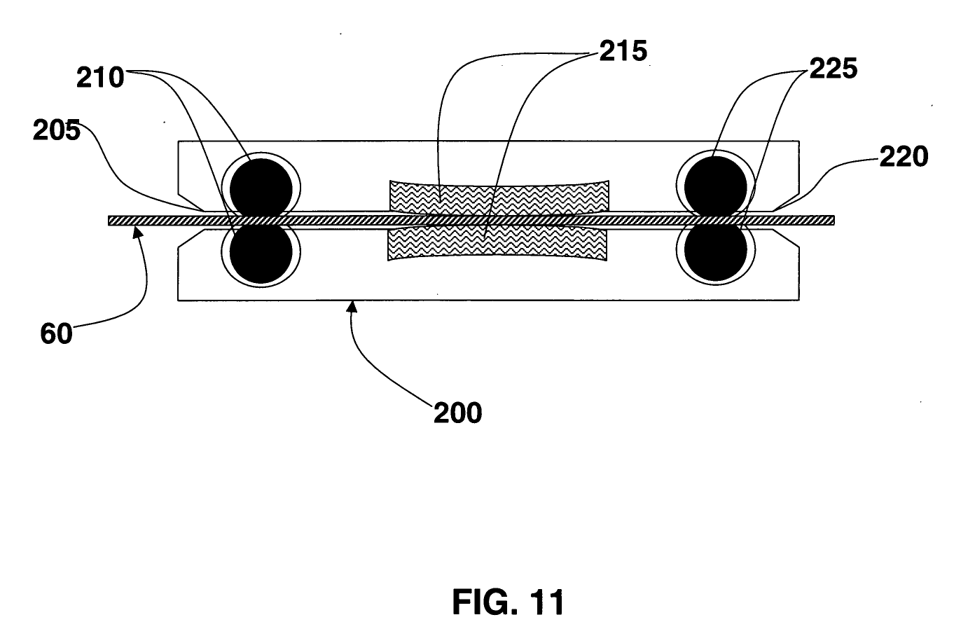

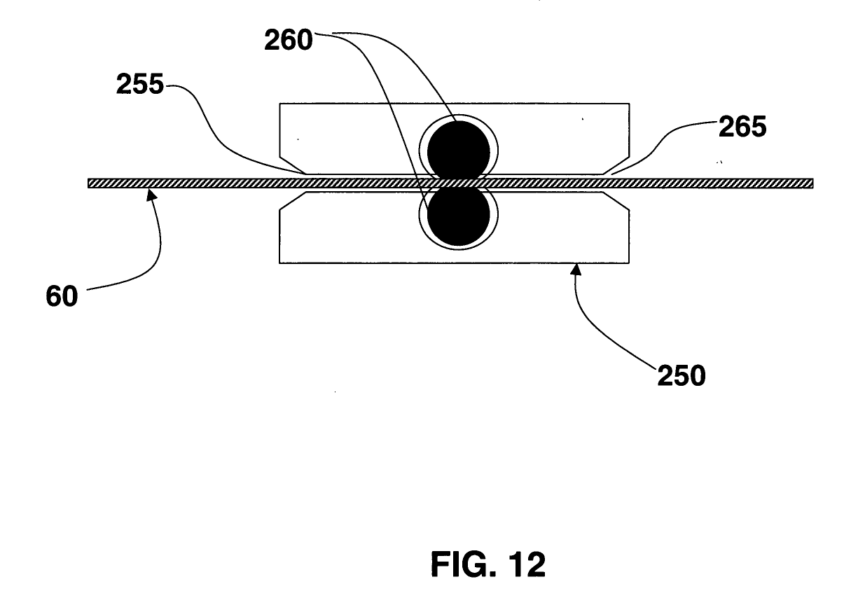

Another method of development involves the use of heat (shown in FIGS. 11 and 12) with a thermally sensitive silver emulsion. The source of heat can be a resistive heater; a heated platen, roller, or mechanical finger; or a light source, such as a laser beam. Now referring to FIG. 11, there is described a method for processing the test strip 60 using a heat processor 200. The heat development is the same as is used in dry film development systems, such as the Kodak DryView X-ray film system. The test strip 60 is fed into the heat processor 200 via an entry port 205 and driven by a pair of entry drive rollers 210 through two heating platens 215 and out through and exit port 220 by a pair of exit drive rollers 225.

A second embodiment of a heat processor 260 is illustrated in FIG. 12. In this embodiment the test strip 60 is fed into the heat processor 250 via an entry port 255 and is conveyed via a pair of heated rollers 260 and exits through an exit port 265. Again the heat development is the same as is used in dry film development systems, such as the Kodak DryView X-ray film system.

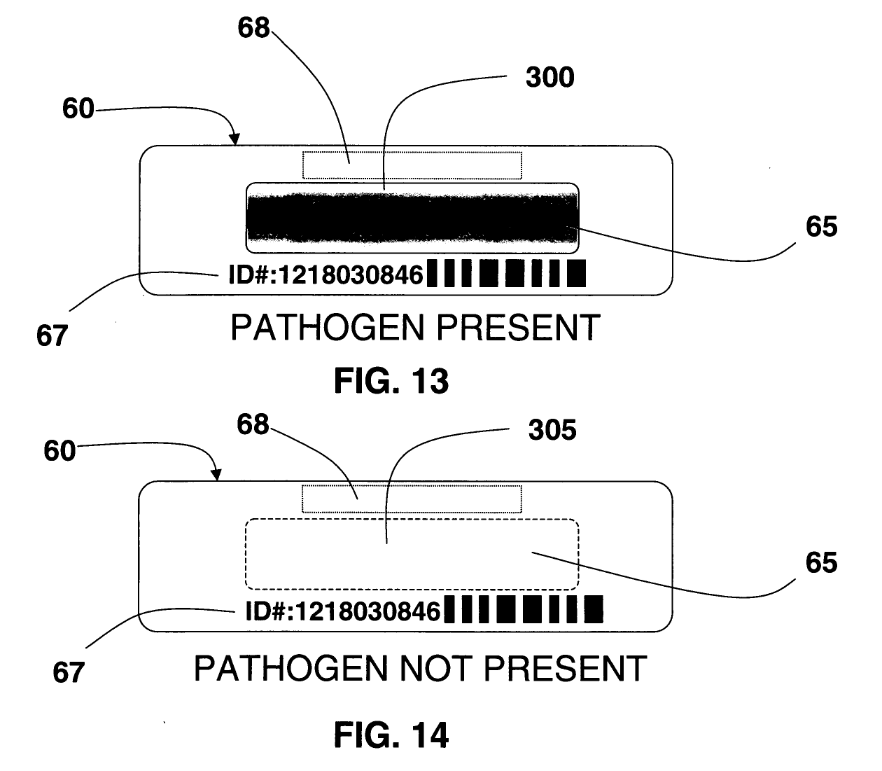

Now referring to FIGS. 13 and 14, the results of processing the test strip 60 (multilayer sensor 5 in the form of a test strip) using the methods described above in FIGS. 10, 11, or 12 are shown. If the test for the pathogen is positive, i.e. the pathogen was present, the sampling area 65 would darken or change color as shown in FIG. 13. In the example shown the test area is darkened as indicated by 300. If the test for the pathogen is negative, i.e. the pathogen was not present, the sampling area 65 would not darken or change color as shown in FIG. 14. In the example shown the test area remains unchanged as indicated by 305.

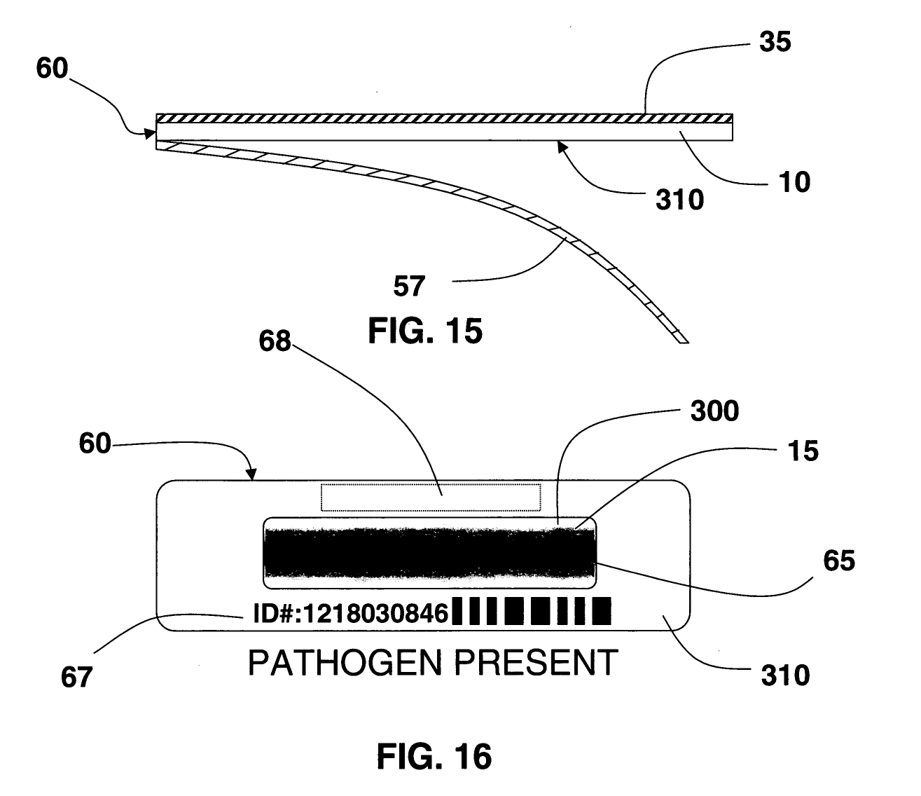

Now referring to FIG. 15, there is illustrated another embodiment of the test strip 60 (multilayer sensor 5) processed using the methods described above in FIGS. 10, 11 and 12 is shown. In this embodiment the blocking layer 57 is located on the opposite side of the support 10 of the test strip 60 from the amplification layer 15. Blocking layer 57 is removable. The blocking layer 57 is peeled away exposing the bottom surface 310 of the support 10 through which the amplification layer 15 of the multilayer sensor 5 is visible as shown in FIG. 16. In one embodiment the blocking layer is light-blocking as described above, however, it need not be diffusible.

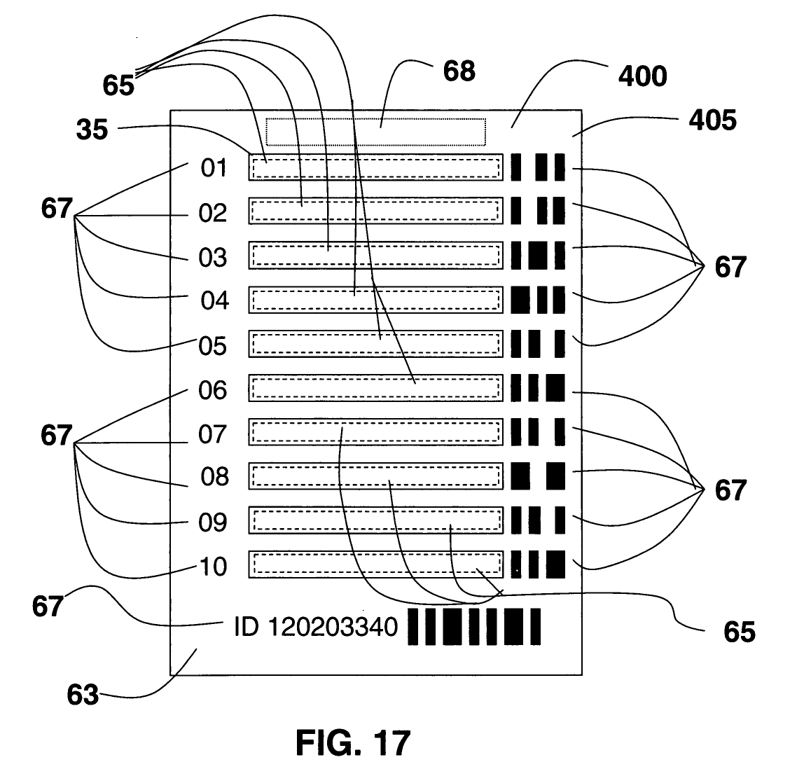

Now referring to FIG. 17, there is illustrated a test strip array 400, comprising a non-sampling area 63 and multiple sampling areas 65 shown. Each sampling area may be uniquely identified with prerecorded data. The test strip array may allow for multiple testing of different test objects for the same target species (i.e. the sampling areas detect the same target species) or multiple testing of one test object or more for a variety of different target species (i.e. the sampling areas can detect different target species). The non-sampling area is used again, for example, to provide ease of handling, space for printed data 67, (prerecorded data) both eye and machine readable, such as an identification number, and a writeable area 68. The test strip array may comprise one or more than one removable protective layers 35, each protecting a sampling area 65 (shown as a hidden view) or a portion of the sampling areas until the individual or group of sampling areas is to be used. It may also comprise one protective layer covering the entire test strip array. In one embodiment, the protective layer may be removed and replaced at various times after exposure. It may be replaced after the sample is applied to the test strip array to protect the sampling area during transport, handling or while other samples are being applied. It may also be replaced after the developer is applied or prior to heat processing allowing the results of the test to be viewed while keeping the sampling area 65 from being contaminated. It also prevents the user from touching the sampling area 65 and being exposed to the pathogen. The removable protective layer may include a fixing or stopping agent to stop development and/or fix the image. The size of the test strip array 400 may be modified to allow processing through conventional black and white or color developing apparatus. As previously described for the test strip, the test strip array may be viewed through the base by removing protective layer 57 not shown. Blocking layer 57 is removable. The blocking layer 57 is peeled away exposing the bottom surface of the support 10 through which the amplification layer 15 of the multilayer sensor 5 is visible. In one embodiment the blocking layer is light-blocking as described above, however, it need not be diffusible.

The method of using the test strip array is generally the same as described for the test strip. Because of the multiple test areas it is generally used with a transfer device. A test object is contacted with a transfer device and the transfer device is placed in contact with one or more sampling areas of the test strip array. In one embodiment multiple test objects are contacted with separate transfer devices and each transfer device is placed in contact with one or more sampling areas of the test strip array. In another embodiment the same test object is contacted with separate transfer devices and each transfer device is placed in contact with one or more sampling areas of the test strip array.

After the test strip 60 or test strip array 400 has been processed using any of the methods described above in FIGS. 10, 11, or 12 or using a conventional photographic processor, the test strip 60 or test strip array 400 may be electronically scanned. The scan may then be digitized and analyzed using a computer (not shown) and the results of the computer analysis outputted via a printer or displayed electronically. The results of several individual test strips 60 or the test strips 60 on a test array 400 may be compared.

The following examples are intended to illustrate, but not to limit the invention.

### EXAMPLES

### Example 1

In this example, no blocking layer was used. All steps occurred in a dark room with safe lights. Standard wet chemical development, including a fix and wash, were used. We used Kodak Polymax II RC paper. A strip of this paper was cut to about 2.5 cm×15 cm. The bottom 1 to 1.5 cm of this film was suspended in a solution consisting of D85 developer. D85 developer is a black-and-white photographic developer containing primarily the LIFCS hydroquinone in a boric acid buffer. The strip was incubated for 5 minutes at 37-40° C. This was done at 3 concentrations of hydroquinone: 0.2 M, 0.02 M, and 0.002 Molar.

The strip was rinsed for 5 seconds and then the bottom 2.5 cm of this film was developed in D76 for 1 minute. The bottom 5 cm region was fixed. The change in size of development and fixing regions allowed a clear comparison of the exposed (to the LIFCS hydroquinone) and unexposed regions of the strip. The density in the different regions was not quantified, but showed contrast between the exposed and unexposed regions. This was estimated as >1.0 O.D. (optical density units) for the 0.2 M sample, less than 1.0 O.D. for the 0.02M sample, and less than 0.5 O.D. for the 0.002 M sample. This change in optical density of the exposed and developed region with change in concentration of the hydroquinone solution shows that the hydroquinone is acting as an LIFCS, and that the density is proportional to the concentration of LIFCS used on the film.

Similar experiments with similar results were conducted for other LIFCS; e.g., with thiosulfate; triaminoborane developer; stannous chloride developer; mercaptoethanol; dimethylaminoethane thiol; and different concentrations of methionine gamma lyase, with and without methionine. Most of these experiments were conducted with different concentrations of LIFCS, some concentrations less than 10-7 molar, with observable contrast in exposed and non-exposed regions, indicating a high degree of sensitivity. It should be noted that the thiols tested and hydroquinone are all expected LIFCS in the prophetic Examples 2 to 4.

Additionally, a film using PET as a substrate, prepared with a gel sub, and then coated with 1.6×10³ mg/m² silver as a silver bromoiodide T-grain emulsion, and a film using PET as a substrate, prepared with a gel sub, and then coated with 1.6×10³ mg/m² silver as a silver chloride cubic emulsion were also exposed with many of the same materials used as LIFCS, yielding developed silver at the exposure site for some of these same LIFCS (but not necessarily the same contrast or optical density). Also, samples of Kodak Polymax II paper were spotted with a drop (0.05 ml) of LIFCS solution, and then incubated. The developed spot showed a remarkably clean, homogeneous spot of even optical density, suggesting that the method and theory of the use of silver halide for chemical amplification clearly applies to many different photographic substrates, emulsion types and compositions, photographic addenda, sample application methods, etc.

### Example 2

This is a prophetic example. In this example, no blocking layer is used. All steps occur in a dark room with safe lights. Standard wet chemical development, including a fix and wash, are used. The substrate for the film is PET, prepared with a gel sub, and then coated with 1.6×10³ mg/m² silver as a silver chloride cubic emulsion and 3.2×10³ mg/m² gel. A sample layer of gelatin incorporating hydroquinone at 1000 mg/m² is coated on top. A strip of this film is cut to about 2.5 cm×7.5 cm.

A 1 mm spot of anti-E. coli antibody in phosphate buffered saline (PBS) is placed on the film and allowed to dry for 1 minute. At a concentration of approximately 100 microgram/ml and a volume per spot of 20 nl, the coverage is estimated at 0.05 mg/m² of antibody.

This 1 mm spot is exposed to E. coli in a solution at approximately 1×10⁴ cfu/ml, and incubated at 37° C. for 10 minutes. Concurrently, on the same strip for the same 10 minutes, but in a different location, a 1 mm spot is exposed to sterile PBS. After exposure for 10 minutes, both spots are rinsed with PBS.

Both spots are then exposed to a 100 microgram/ml solution of enzyme-conjugated anti-E. coli antibody. In this case, the enzyme is p-benzoquinone reductase. Both spots are exposed for 10 minutes. After exposure for 10 minutes, both spots are rinsed with PBS.

The film is developed for 1 minute in Kodak D76, a known black-and-white developer. The film strip is fixed for 30 seconds, and then washed for 30 seconds. The developed film shows a black spot at approximately the location of the exposure to E. coli, and very little black elsewhere, including the spot exposed to only PBS. The ratio of the density of the E. coli spot to the PBS spot is approximately 0.7 O.D. The significance of the optical density is only to show that the E. coli is detected at 1×10⁴ cfu/ml as compared to a sterile solution.

### Example 3

This is a prophetic example. In this example, no blocking layer is used. All steps occur in a dark room with safe lights. Standard wet chemical development, including a fix and wash, are used. The substrate for the film is PET, prepared with a gel sub, and then coated with 1.6×10³ mg/m² silver as a silver chloride cubic emulsion and 3.2×10³ mg/m² gel. A sample layer of gelatin incorporating polystyrene beads (<1 micron diameter) that were functionalized with methionine (approximately 10% functionalized) is coated on top at a coverage of beads of approximately 200 mg/m². A strip of this film is cut to about 2.5 cm×7.5 cm. An E. coli solution of approximately 1×10⁴ cfU/ml is spotted on the film (0.01 ml). A PBS solution is spotted on the film (0.01 ml). The films are incubated at 37° C. for 20 minutes, and then developed for 1 minute in Kodak D76. The film strip is fixed for 30 seconds, and then washed for 30 seconds. The developed film shows a black spot at approximately the location of the exposure to E. coli, and very little black elsewhere, including the spot exposed to only PBS. The ratio of the density of the E. coli spot to the PBS spot is approximately 0.5 O.D. The significance of the optical density is only to show that the E. coli is detected at 1×10⁴ cfu/ml as compared to a sterile solution.

### Example 4

This is a prophetic example. In this example, no blocking layer is used. All steps occur in a dark room with safe lights. Standard wet chemical development, including a fix and wash, are used. The substrate for the film is PET, prepared with a gel sub, and then coated with 1.6×10³ mg/m² silver as a silver chloride cubic emulsion and 3.2×10³ mg/m² gel. A sample layer of gelatin incorporating a modified oligomeric aluminum oxide is coated on top at a coverage of approximately 100 mg/m². A solution of O,S-di-Et methylphosphonothioate (an organo-phosphate compound similar to Sarin, but only mildly toxic) at a concentration of 10⁻⁵ molar of O,S-di-Et methylphosphonothioate, is spotted (0.01 ml) onto the film. The film is incubated at 50° C. for 20 minutes, and then developed for 1 minute in Kodak D76. The film strip is fixed for 30 seconds, and then washed for 30 seconds. The developed film shows a black spot at approximately the location of the exposure to the O,S-di-Et methylphosphonothioate solution, and very little black elsewhere. The ratio of the density of the O,S-di-Et methylphosphonothioate spot to the density in the rest of the film is approximately 0.6 O.D. The significance of the optical density is only to show that the O,S-di-Et methylphosphonothioate is detected at 10⁻⁵ M as compared to a non-exposed region of the strip.

The invention has been described in detail with particular reference to certain preferred embodiments thereof, but it will be understood that variations and modifications can be effected within the spirit and scope of the invention.

Parts List:

5 multilayer sensor
10 support layer
15 signal amplification layer
18 top surface
20 sampling layer
22 top surface
25 light-blocking layer
30 top surface
35 removable protective layer
40 subbing layer
45 release layer
50 arrow
5a, b, c, d areas
55 top surface
57 blocking layer
58 bottom surface
59 test kit
60 test strip
63 non-sampling area
65 sampling area
67 printed data
68 writeable area
70 arrow
75 test object
80 arrow
81 arrow
82 arrow
83 sample
85 swab
87 arrow
90 arrow
93 arrow
95 applicator
100 developer
105 arrow
110 pad
115 flat surface
200 heat processor
205 entry port
210 entry drive rollers
215 heating platens
220 exit port
225 exit drive rollers
250 heat processor
255 entry port
260 heated rollers
265 exit port
300 darkened sampling area
305 unchanged sampling area
310 bottom surface
400 test strip array

1. A test strip comprising a support having thereon a non-sampling area and a sampling area wherein said sampling area further comprises a sampling layer which can react with a target species to form or release a signal compound which is capable of effecting a reaction with silver halide to form a latent image, and a signal amplification layer comprising silver halide.

2. The test strip of claim 1 further comprising a protective layer covering at least the sampling area.

3. The test strip of claim 1 further comprising a release layer.

4. The test strip of claim 1 herein the support is polyethylene terephthalate.

5. The test strip of claim 1 wherein the sampling area is surrounded by the non-sampling area.

6. The test strip of claim 1 wherein the sampling area is located at one edge portion of the test strip.

7. The test strip of claim 2 wherein the protective layer is light blocking.

8. The test strip of claim 2 wherein the protective layer is removable.

9. The test strip of claim 8 wherein the protective layer is light blocking.

10. The test strip of claim 8 wherein the protective layer is replaceable after being removed.

11. The test strip of claim 1 further comprising prerecorded data which is visually readable and/or machine readable.

12. The test strip of claim 1 further comprising a blocking layer on the opposite side of the support from the sampling area.

13. The test strip of claim 12 further wherein the blocking layer on the opposite side of the support is light blocking.

14. The test strip of claim 12 wherein the blocking layer on the opposite side of the support is removable.

15. The test strip of claim 14 wherein the blocking layer on the opposite side of the support is replaceable after being removed.

16. The test strip of claim 1 wherein the non-sampling area is suitable for recording data.

17. The test strip of claim 1 wherein the support is opaque.

18. The test strip of claim 1 wherein the sampling area can detect more than one type of target species.

19. The test strip of claim 1 wherein the sampling area further comprises an additional layer which blocks electromagnetic radiation which is capable of exposing the silver halide and which is located between the sampling layer and the silver halide amplification layer.

20. The test strip of claim 1 wherein the signal compound can react with a secondary compound contained in the silver halide layer which can then react with the silver halide to form a latent image.

21. The test strip of claim 1 wherein the signal compound can react with the silver halide to form a latent image.

22. The test strip of claim 1 wherein the sampling layer also blocks electromagnetic radiation which is capable of exposing the silver halide.

23. The test strip of claim 1 wherein the silver halide layer contains a dye image forming coupler.

24. The test strip of claim 19 wherein the light blocking layer is diffusible.

25. The test strip claim 2 wherein the protective layer is diffusible to the target species.

26. The test strip of claim 19 wherein the light-blocking layer is opaque.

27. The test strip of claim 1 wherein the silver halide is sensitized.

28. The test strip of claim 1 wherein the signal compound is capable of effecting a reaction through a chemical cascade.

29. The test strip of claim 1 wherein the signal compound is formed through a chemical cascade reaction.

30. The test strip of claim 1 wherein the signal compound is capable of effecting a reaction with the silver halide by reacting with the light-blocking layer to effect a reaction with silver halide to form a latent image.

31. The test strip of claim 1 wherein the sampling layer and the signal amplification layer comprising silver halide are the same layer.

32. The test strip of claim 1 wherein the target species is E. coli.

33. The test strip of claim 1 wherein the sampling area further comprises a filter layer.

34. The test strip of claim 1 wherein the silver halide amplification layer comprises silver halide that upon LIFCS exposure provides a latent image in exposed grains that are capable of acting as a catalyst for the subsequent formation of a silver image in a development step, (b) a non-LIFCS sensitive source of reducible silver ions, (c) a reducing composition for the reducible silver ions, and (d) a hydrophilic or hydrophobic binder.

35. A method of detecting a target species comprising contacting the test strip of claim 1 with the material to be tested and allowing the silver halide to form a latent image.

36. The method of claim 35 further comprising the step of developing the latent image to form a detectable signal.

37. The method of claim 35 wherein the detectable signal is measurable.

38. The method of claim 35 wherein the latent image is developed by heat.

39. The method of claim 35 wherein the latent image is developed by chemical processing.

40. The method of claim 36 wherein the developer is applied using an applicator

41. The method of claim 36 further comprising reading the signal.

42. The method of claim 41 wherein the signal is read visually.

43. The method of claim 41 wherein the signal is read by a densitometer.

44. The method of claim 41 wherein the test strip is electronically scanned.

45. The method of claim 44 wherein the results of the electronic scan are analyzed using a computer.

46. The method of claim 35 wherein the test strip is placed in contact with a test object.

47. The method of claim 35 wherein the test object is contacted with a transfer device and the transfer device is placed in contact with the test strip.

48. The method of claim 35 wherein the test strip comprises a protective layer and the protective layer is removed during testing and then replaced.

49. The method of claim 48 wherein the protective layer is light blocking.

50. The method of claim 36 wherein the test strip further comprises a blocking layer on the opposite side of the support from the sampling area and wherein the developed test strip is viewed through the support by removing the blocking layer.

51. The method of claim 50 wherein the blocking layer is opaque.

52. A kit comprising a developing device and the test strip of claim 1.

53. The kit of claim 52 further comprising a transfer device.

54. The kit of claim 53 wherein the transfer device is a swab or a device for transferring liquid.

55. The kit of claim 52 wherein the developing device is a heat developing apparatus.

56. The kit of claim 52 wherein the developing device is an applicator for chemical developer.

57. The kit of claim 52 comprising multiple test strips.

58. The kit of claim 52 further comprising a marking device for recording data.

59. A kit comprising a transfer device and the test strip of claim 1.

60. The kit of claim 59 further comprising a developing device.

61. The kit of claim 59 wherein the transfer device is a swab or a device for transferring liquid.

62. The kit of claim 60 wherein the developing device is a heat developing apparatus.

63. The kit of claim 60 wherein the developing device is an applicator for chemical developer.

64. The kit of claim 59 comprising multiple test strips.

65. The kit of claim 59 further comprising a marking device for recording data.

66. A test strip array comprising a non-sampling area and multiple sampling areas wherein each sampling area further comprises a sampling layer which can react with a target species to form or release a signal compound which is capable of effecting a reaction with silver halide to form a latent image, and a signal amplification layer comprising silver halide.

67. The test strip array of claim 66 wherein the sampling areas all detect the same target species.

68. The test strip array of claim 66 wherein the sampling areas can detect different target species.

69. The test strip array of claim 66 wherein each sampling area or a group of sampling areas is identified with prerecorded data.

70. The test strip array of claim 66 further comprising a protective layer covering all or a portion of the sampling areas.

71. The test strip array of claim 70 wherein there is more than one protective layer, each covering a portion of the sampling area.

72. The test strip array of claim 66 wherein the sampling areas are surrounded by the non-sampling area.

73. The test strip array of claim 70 wherein the protective layer is light blocking.

74. The test strip array of claim 70 wherein the protective layer or a portion thereof is removable.

75. The test strip array of claim 74 wherein the protective layer is light blocking.

76. The test strip array of claim 74 wherein the protective layer or a portion thereof is replaceable after being removed.

77. The test strip array of claim 66 further comprising prerecorded data which is visually readable and/or machine readable.

78. The test strip of claim 66 further comprising a blocking layer on the opposite side of the support from the sampling area.

79. The test strip array of claim 78 wherein the blocking layer on the opposite side of the support is light blocking.

80. The test strip array of claim 78 wherein the blocking layer on the opposite side of the support is removable.

81. The test strip array of claim 78 wherein the blocking layer on the opposite side of the support is replaceable after being removed.

82. The test strip array of claim 66 wherein the non-sampling area is suitable for recording data.

83. The test strip array of claim 66 wherein the support is opaque.

84. The test strip array of claim 66 wherein each sampling area further comprises an additional layer which blocks electromagnetic radiation which is capable of exposing the silver halide and which is located between the sampling layer and the silver halide amplification layer.

85. The test strip array of claim 66 wherein the signal compound can react with a secondary compound contained in the silver halide layer which can then react with the silver halide to form a latent image.

86. The test strip array of claim 66 wherein the signal compound can react with the silver halide to form a latent image.

87. The test strip array of claim 66 wherein the sampling layer also blocks electromagnetic radiation which is capable of exposing the silver halide.

88. The test strip array of claim 66 wherein the silver halide layer contains a dye image forming coupler.

89. The test strip array of claim 84 wherein the light-blocking layer is diffusible.

90. The test strip array claim 70 wherein the protective layer is diffusible to the target species.

91. The test strip array of claim 66 wherein the silver halide is sensitized.

92. The test strip array of claim 66 wherein the signal compound is capable of effecting a reaction through a chemical cascade.

93. The test strip array of claim 66 wherein the signal compound is formed through a chemical cascade reaction.

94. The test strip array of claim 84 wherein the signal compound is capable of effecting a reaction with the silver halide by reacting with the light-blocking layer to effect a reaction with silver halide to form a latent image.

95. The test strip array of claim 66 wherein the sampling layer and the signal amplification layer comprising silver halide are the same layer.

96. The test strip array of claim 66 wherein the target species is E. coli.

97. The test strip array of claim 66 wherein each sampling area further comprises a filter layer.

98. The test strip array of claim 66 wherein the silver halide amplification layer comprises silver halide that upon LIFCS exposure provides a latent image in exposed grains that are capable of acting as a catalyst for the subsequent formation of a silver image in a development step, (b) a non-LIFCS sensitive source of reducible silver ions, (c) a reducing composition for the reducible silver ions, and (d) a hydrophilic or hydrophobic binder.

99. The test strip array of claim 70 wherein the protective layer comprises a fixing or stopping agent.

100. The test strip of claim 2 wherein the protective layer comprises a fixing or stopping agent.

101. A method of detecting a target species comprising contacting all or a portion of the sampling areas of the test strip array of claim 66 with the material to be tested and allowing the silver halide to form a latent image.

102. The method of claim 101 further comprising the step of developing the latent image to form a detectable signal.

103. The method of claim 102 wherein the detectable signal is measurable.

104. The method of claim 102 wherein the latent image is developed by heat.

105. The method of claim 102 wherein the latent image is developed by chemical processing.

106. The method of claim 105 wherein the test strip array is developed in a conventional developing apparatus.

107. The method of claim 105 wherein the developer is applied using an applicator

108. The method of claim 102 further comprising reading the signal either visually or with a densitometer.

109. The method of claim 102 wherein the test strip is electronically scanned.

110. The method of claim 109 wherein the results of the electronic scan are analyzed using a computer.

111. The method of claim 102 wherein the test object is contacted with a transfer device and the transfer device is placed in contact with one or more sampling areas of the test strip array.

112. The method of claim 102 wherein multiple test objects are contacted with separate transfer devices and each transfer device is placed in contact with one or more sampling areas of the test strip array.

113. The method of claim 102 wherein the same test object is contacted with separate transfer devices and each transfer device is placed in contact with one or more sampling areas of the test strip array.

114. The method of claim 102 wherein the test strip array comprises a protective layer and the protective layer or a portion thereof is removed during testing and then replaced.

115. The method of claim 114 wherein the protective layer is light blocking.

116. The method of claim 102 wherein the test strip array further comprises a blocking layer on the opposite side of the support from the sampling areas and wherein the developed test strip is viewed through the support by removing the blocking layer.

117. The method of claim 116 wherein the blocking layer is opaque.
